(19) United States
(12) Patent Application Publication
(10) Pub. No.: US 2025/0156607 A1
(43) Pub. Date: May 15, 2025

(54) TECHNIQUES FOR GENERATIVE DESIGN BASED ON LARGE LANGUAGE MODELS

(71) Applicant: AUTODESK, INC., San Francisco, CA (US)

(72) Inventors: Adam James GAIER, Bonn (DE); Lorenzo VILLAGGI, Brooklyn, NY (US); James STODDART, Atlanta, GA (US)

(21) Appl. No.: 18/737,863

(22) Filed: Jun. 7, 2024

Related U.S. Application Data
(60) Provisional application No. 63/597,651, filed on Nov. 9, 2023.

(51) Int. Cl. G06F 30/27; G06F 30/13; G06F 111/02

(52) U.S. Cl. CPC G06F 30/27; G06F 30/13; G06F 2111/02

(57) ABSTRACT

Techniques for generative design based on large language models include receiving one or more design prompts; generating, based on the one or more design prompts, a plurality of design tokens using a large language model; generating a conceptual design layout from the plurality of design tokens; and optimizing the conceptual design layout to generate a compliant design layout.

### CROSS-REFERENCE TO RELATED APPLICATIONS

This application claims priority benefit of the United States Provisional Patent Application titled, “TECHNIQUES FOR GENERATING TILE-BASED DESIGNS USING NATURAL LANGUAGE INPUT,” filed on Nov. 9, 2023, and having Ser. No. 63/597,651. The subject matter of this related application is hereby incorporated herein by reference.

### BACKGROUND

### Field of the Various Embodiments

Embodiments of the present disclosure relate generally to generative design and machine learning, and more specifically, to techniques for generative design based on large language models.

### Description of the Related Art

The field of generative design in architecture and engineering includes creating innovative and diverse designs that meet specified constraints. Generative design applies computational techniques to produce architectural layouts, building structures, and urban planning solutions. Generative design is used in various applications, including but not limited to the development of sustainable buildings, optimization of interior spaces, and creation of aesthetically pleasing and functional urban environments. By leveraging computational power and extensive datasets, generative design enables architects and engineers to explore a vast array of design possibilities, ensuring that the resulting solutions are both innovative and compliant with specific performance metrics and regulatory standards. Generative design facilitates the creation of designs that are tailored to environmental, spatial, and user-specific requirements, thereby enhancing the overall design process and outcomes in the built environment.

Some conventional approaches for generative design involve heuristic-based methods, such as genetic algorithms and other optimization techniques. Heuristics-based methods typically explore a broad solution space to identify optimal designs based on a set of performance metrics. For example, genetic algorithms simulate the process of natural selection by iteratively evolving a population of design solutions towards improved performance. Each design solution is evaluated based on metrics such as structural stability, aesthetic appeal, environmental impact, and space utilization. In the context of urban planning, heuristics-based methods can be used to optimize the layout of parks, residential areas, and commercial spaces to maximize green space while ensuring efficient land use. Similarly, in building design, genetic algorithms can help in optimizing the placement of windows, walls, and other architectural elements to enhance energy efficiency and natural lighting. Other heuristic-based methods, such as simulated annealing, particle swarm optimization, and/or the like, are also employed to refine designs by mimicking physical processes or social behaviors observed in nature. Heuristics-based approaches allow for the generation of a diverse set of high-quality design alternatives that meet specific requirements, thereby aiding architects and engineers in selecting the most suitable designs.

Another conventional approach for generative design leverages machine learning models trained on extensive datasets to generate architectural layouts and engineering designs. Machine learning models can learn complex patterns and relationships from large volumes of data, enabling the models to generate innovative and high-quality design solutions that meet specified constraints. For example, neural networks can be trained on datasets containing a variety of building layouts, structural configurations, and design elements, allowing the models to generate new designs that incorporate desirable features from the training design data.

One drawback of conventional approaches for generative design, in particular approaches employing heuristic-based optimization, is that conventional approaches often fail to provide the necessary diversity in design outputs, leading to suboptimal performance in practical design applications. Moreover, conventional approaches are computationally intensive and do not scale well to complex architectural projects that require a high level of detail and compliance with numerous constraints. Furthermore, conventional approaches often require significant manual intervention to fine-tune parameters and constraints, which can introduce bias and reduce the overall efficiency of the design process.

Another drawback of conventional approaches for generative design, in particular approaches based on machine learning, is the reliance on the availability of large, high-quality design datasets to train the machine learning models, which can be difficult and time-consuming to compile. Furthermore, the computational resources required for training and running machine learning models can be substantial. Additionally, machine learning models can produce designs that, while innovative, do not fully comply with all practical constraints and standards without further refinement and intervention by human experts.

As the foregoing indicates, what is needed in the art are more effective techniques for generative design.

### SUMMARY

Various embodiments of the present disclosure set forth a computer-implemented method for generation a design. The method includes receiving one or more design prompts; generating, based on the one or more design prompts, a plurality of design tokens using a large language model; generating a conceptual design layout from the plurality of design tokens; and optimizing the conceptual design layout to generate a compliant design layout.

Other embodiments include, without limitation, one or more computer readable media including instructions for performing one or more aspects of the disclosed techniques and a system that implements one or more aspects of the disclosed techniques.

One technical advantage of the disclosed techniques relative to the prior art is the ability to generate diverse and high-performing design outputs that address a broad range of design goals and constraints. By integrating the WFC algorithm and iterative mutation processes, the disclosed techniques overcome the limitations of conventional heuristic-based optimization approaches, which often fail to provide sufficient diversity in design outputs and require extensive manual intervention and fine-tuning. Another advantage of the disclosed techniques is the reduced reliance on large, high-quality design datasets and significant computational resources. By using the WFC algorithm and a genetic algorithm for design selection and mutation, the disclosed techniques reduce the dependency on extensive datasets and allow for the generation of compliant designs that adhere to practical constraints and standards. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of the various embodiments;

FIG. 2 illustrates a block diagram of a computer-based system according to various embodiments;

FIG. 3 is a more detailed illustration of the model trainer of FIG. 2, according to various embodiments;

FIG. 4A is a more detailed illustration of the design generation module of FIG. 3, according to various embodiments;

FIG. 4B illustrates an example set of candidate design layouts in a design grid, according to various embodiments;

FIG. 4C illustrates the mutation process of an example selected candidate design layout according to various embodiments;

FIG. 5 is a more detailed illustration of the design generation application of FIG. 2, according to various embodiments;

FIG. 6A is a more detailed illustration of the design optimizer of FIG. 5, according to various embodiments;

FIG. 6B is an example illustration of the operation of design generation application of FIG. 2, according to various embodiments;

FIG. 6C illustrates the optimization process of an example conceptual design layout to generate a corresponding compliant design layout, according to various embodiments;

FIG. 7 sets forth a flow diagram of method steps for generating design data and training a large language model, according to various embodiments;

FIG. 8 sets forth a flow diagram of method steps for generating design layouts, according to various embodiments;

FIG. 9 sets forth a flow diagram of method steps for generating a detailed design, according to various embodiments; and

FIG. 10 sets forth a flow diagram of method steps for optimizing a conceptual design layout, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

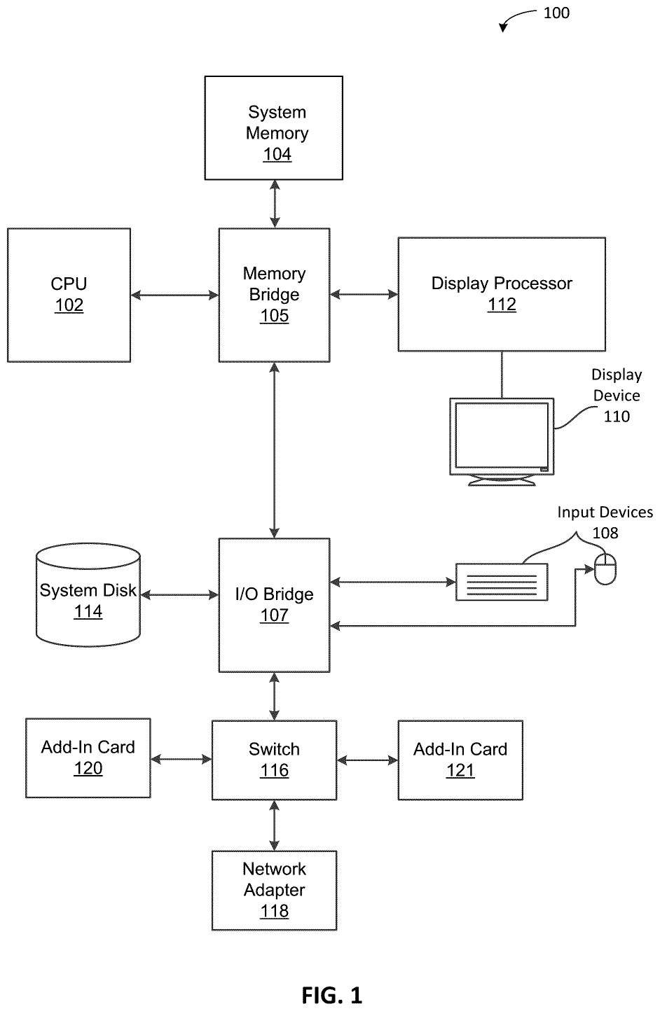

FIG. 1 depicts one architecture of a system 100 within which embodiments of the present disclosure can be implemented. FIG. 1 in no way limits or is intended to limit the scope of the present disclosure. In various implementations, system 100 can be an augmented reality, virtual reality, or mixed reality system or device, a personal computer, video game console, personal digital assistant, mobile phone, mobile device or any other device suitable for practicing one or more embodiments of the present invention. Further, in various embodiments, any combination of two or more systems 100 can be coupled together to practice one or more aspects of the present invention.

As shown, system 100 includes a central processing unit (CPU) 102 and a system memory 104 communicating via a bus path that may include a memory bridge 105. CPU 102 includes one or more processing cores, and, in operation, CPU 102 is the master processor of system 100, controlling and coordinating operations of other system components. System memory 104 stores software applications and data for use by CPU 102. CPU 102 runs software applications and optionally an operating system. Memory bridge 105, which can be, e.g., a Northbridge chip, is connected via a bus or other communication path (e.g., a HyperTransport link) to an I/O (input/output) bridge 107. I/O bridge 107, which may be, e.g., a Southbridge chip, receives user input from one or more user input devices 108 (e.g., keyboard, mouse, joystick, digitizer tablets, touch pads, touch screens, still or video cameras, motion sensors, and/or microphones) and forwards the input to CPU 102 via memory bridge 105.

A display processor 112 is coupled to memory bridge 105 via a bus or other communication path (e.g., a PCI Express, Accelerated Graphics Port, or HyperTransport link); in one embodiment display processor 112 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 104.

Display processor 112 periodically delivers pixels to a display device 110 (e.g., a screen or conventional CRT, plasma, OLED, SED or LCD based monitor or television). Additionally, display processor 112 can output pixels to film recorders adapted to reproduce computer generated images on photographic film. Display processor 112 can provide display device 110 with an analog or digital signal. In various embodiments, one or more of the various graphical user interfaces are displayed to one or more users via display device 110, and the one or more users can input data into and receive visual output from those various graphical user interfaces.

A system disk 114 is also connected to I/O bridge 107 and can be configured to store content and applications and data for use by CPU 102 and display processor 112. System disk 114 provides non-volatile storage for applications and data and may include fixed or removable hard disk drives, flash memory devices, and CD-ROM, DVD-ROM, Blu-ray, HD-DVD, or other magnetic, optical, or solid state storage devices.

A switch 116 provides connections between I/O bridge 107 and other components such as a network adapter 118 and various add-in cards 120 and 121. Network adapter 118 allows system 100 to communicate with other systems via an electronic communications network, and can include wired or wireless communication over local area networks and wide area networks such as the Internet.

Other components (not shown), including USB or other port connections, film recording devices, and the like, may also be connected to I/O bridge 107. For example, an audio processor may be used to generate analog or digital audio output from instructions and/or data provided by CPU 102, system memory 104, or system disk 114. Communication paths interconnecting the various components in FIG. 1 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 112 incorporates circuitry optimized for graphics and video processing, including, for example, video output circuitry, and constitutes a graphics processing unit (GPU). In another embodiment, display processor 112 incorporates circuitry optimized for general purpose processing. In yet another embodiment, display processor 112 may be integrated with one or more other system elements, such as the memory bridge 105, CPU 102, and I/O bridge 107 to form a system on chip (SoC). In still further embodiments, display processor 112 is omitted and software executed by CPU 102 performs the functions of display processor 112.

Pixel data can be provided to display processor 112 directly from CPU 102. In some embodiments of the present invention, instructions and/or data representing a scene are provided to a render farm or a set of server computers, each similar to system 100, via network adapter 118 or system disk 114. The render farm generates one or more rendered images of the scene using the provided instructions and/or data. These rendered images may be stored on computer-readable media in a digital format and optionally returned to system 100 for display. Similarly, stereo image pairs processed by display processor 112 may be output to other systems for display, stored in system disk 114, or stored on computer-readable media in a digital format.

Alternatively, CPU 102 provides display processor 112 with data and/or instructions defining the desired output images, from which display processor 112 generates the pixel data of one or more output images, including characterizing and/or adjusting the offset between stereo image pairs. The data and/or instructions defining the desired output images can be stored in system memory 104 or graphics memory within display processor 112. In an embodiment, display processor 112 includes 3D rendering capabilities for generating pixel data for output images from instructions and data defining the geometry, lighting shading, texturing, motion, and/or camera parameters for a scene. Display processor 112 can further include one or more programmable execution units capable of executing shader programs, tone mapping programs, and the like.

Further, in other embodiments, CPU 102 or display processor 112 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 102, display processor 112, or one or more other processing devices or any combination of these different processors.

CPU 102, render farm, and/or display processor 112 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 100 may be a robot or robotic device and may include CPU 102 and/or other processing units or devices and system memory 104. In such embodiments, system 100 may or may not include other elements shown in FIG. 1. System memory 104 and/or other memory units or devices in system 100 may include instructions that, when executed, cause the robot or robotic device represented by system 100 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 104 is connected to CPU 102 directly rather than through a bridge, and other devices communicate with system memory 104 via memory bridge 105 and CPU 102. In other alternative topologies display processor 112 is connected to I/O bridge 107 or directly to CPU 102, rather than to memory bridge 105. In still other embodiments, I/O bridge 107 and memory bridge 105 might be integrated into a single chip. The particular components shown herein are optional; for instance, any number of add-in cards or peripheral devices might be supported. In some embodiments, switch 116 is eliminated, and network adapter 118 and add-in cards 120, 121 connect directly to I/O bridge 107.

### Generative Design Using Large Language Models

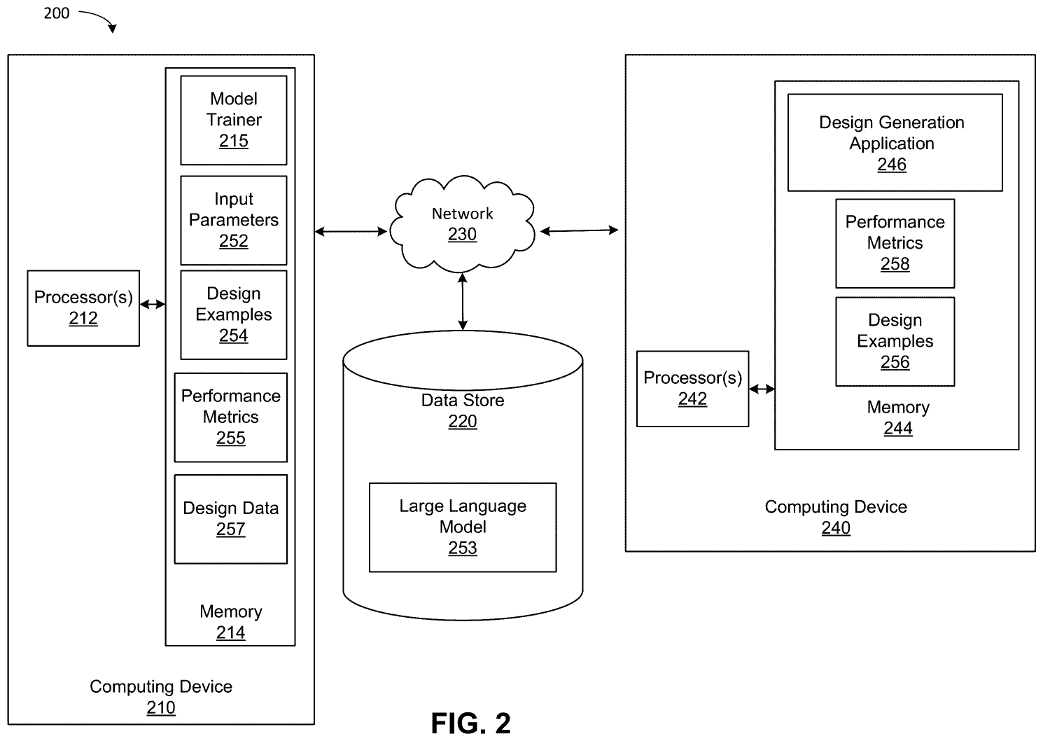

FIG. 2 illustrates a block diagram of a computer-based system 200 according to various embodiments. As shown, system 200 includes, without limitation, computing devices 210 and 240, a data store 220, and a network 230. Computing device 210 includes, without limitation, one or more processors 212 and memory 214. Memory 214 includes, without limitation, a model trainer 215, input parameters 252, design examples 254, performance metrics 255, and design data 257. Data store 220 includes, without limitation, a large language model 253. Computing device 240 includes, without limitation, one or more processors 242 and memory 244. Memory 244 includes, without limitation, a design generation application 246, performance metrics 258, and design examples 256. And although the embodiments of FIG. 2 are described in the context of architectural design examples, it is understood that the disclosed techniques are also applicable to other areas of design, such as industrial design, graphic design, automotive design, and/or the like.

Computing device 210 shown herein is for illustrative purposes only, and variations and modifications in the design and arrangement of computing device 210, without departing from the scope of the present disclosure. In some examples, computing device 210 includes an architecture consistent with the architecture of system 100. For example, the number of processors 212, the number of and/or type of memories 214, and/or the number of applications and or data stored in memory 214 can be modified as desired. In some embodiments, any combination of processor(s) 212 and/or memory 214 can be included in and/or replaced with any type of virtual computing system, distributed computing system, and/or cloud computing environment, such as a public, private, or a hybrid cloud system.

Each of processor(s) 212 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 212 can be any technically feasible hardware unit capable of processing data and/or executing software applications. During operation, processor(s) 212 can receive user input from input devices (not shown), such as a keyboard or a mouse.

Memory 214 of computing device 210 stores content, such as software applications and data, for use by processor(s) 212. As shown, memory 214 includes, without limitation, model trainer 215, input parameters 252, design examples 254, performance metrics 255, and design data 257. Memory 214 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 214. The storage can include any number and type of external memories that are accessible to processor(s) 212. For example, and without limitation, the storage can include a Secure Digital Card, an external Flash memory, a portable CD-ROM, an optical storage device, a magnetic storage device, and/or any suitable combination of the foregoing.

Model trainer 215 is stored in memory 214 and is executed by processor(s) 212. Model trainer 215 uses input parameters 252, design examples 254, and performance metrics 255 to generate design data 257. Input parameters 252 includes but are not limited to specific requirements for an architectural design, such as the desired number of residential units, green space requirements, zoning laws, building height restrictions, environmental impact considerations, and/or the like in an architectural design example. For example, input parameters 252 can include a parameter which specifies that the design should include at least 20% green space and adhere to local building codes. Input parameters 252 can also apply to other design domains. For example, in industrial design, input parameters 252 can include material specifications, manufacturing constraints, and ergonomic requirements. In graphic design, input parameters 252 can include color schemes, layout dimensions, and branding guidelines. In automotive design, input parameters 252 can include aerodynamics, safety standards, and fuel efficiency.

Design examples 254 are pre-existing design layouts that serve as references or templates for generating new designs and inferring design constraints. Design examples 254 can include successful architectural plans, common building configurations, innovative design solutions, and/or the like. For example, design examples 254 can include building designs or layouts that efficiently utilize space while performing well on one or more performance metrics. Performance metrics 255 are used to evaluate the quality and feasibility of the generated designs. Performance metrics 255 can assess factors, such as energy efficiency, aesthetic value, structural integrity, cost-effectiveness, user satisfaction, and/or the like. For example, performance metrics 255 can include a metric for measuring the carbon footprint of a building or the daylight exposure in residential units.

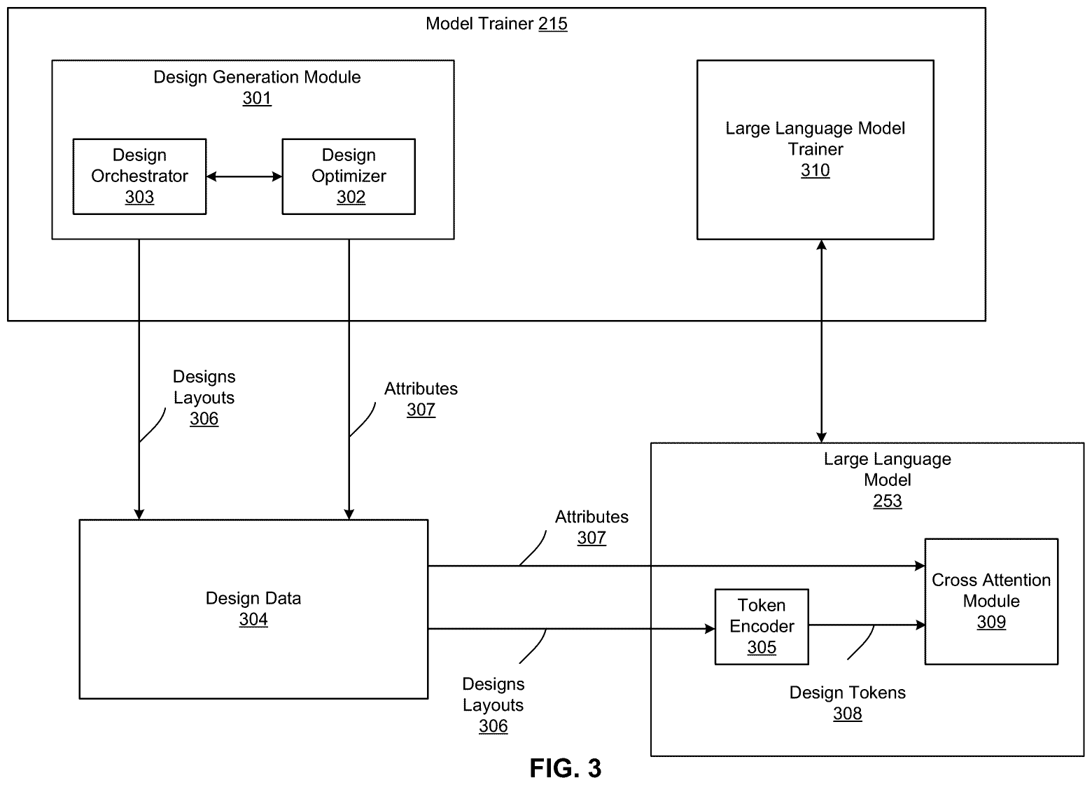

Model trainer 215 is also configured to train one or more machine learning models with design data 257, such as large language model 253, that are used to assist in design generation. Model trainer 215 can employ any suitable techniques to train the machine learning model(s). For example, model trainer 215 can use techniques, such as fine-tuning with domain-specific data, transfer learning, or curriculum learning to train the one or more machine learning model(s). Model trainer 215 is discussed in greater detail below in conjunction with FIGS. 3, 4A-4C and FIGS. 7-8. After model trainer 215 trains large language model 253, model trainer 215 stores large language model 253 in data store 220 for access by other computing devices, such as computing device 240.

Data store 220 can include any storage device or devices, such as fixed disc drive(s), flash drive(s), optical storage, network attached storage (NAS), and/or a storage area-network (SAN). Although shown as accessible over network 230, in some embodiments computing device 210 can include data store 220. As shown, data store 220 is storing large language model 253.

Large language model 253 is a data-driven model, which includes a set of parameters that have been optimized by model trainer 215 to assist in the design generation. For example, large language model 253 can be based on Transformer architectures, which are capable of understanding and generating human-like text. Other examples of models suitable for large language model 253 include but are not limited to fine-tuned Bidirectional Encoder Representations (BERT), Generative Pre-trained Transformer (GPT), or other autoregressive models. In various embodiments, the parameters of large language model 253 are typically learned using backpropagation and stored as part of large language model in data store 220. In at least one embodiment, the parameters can be updated as new data becomes available, as the design requirements evolve, or as additional user inputs are received from one or more I/O device(s) (not shown). Once trained, large language model 253 can be deployed in any suitable manner, such as via a design generation application 246.

Network 230 can be a wide area network (WAN), such as the Internet, a local area network (LAN), a cellular network, and/or any other suitable network. Computing devices 210 and 240 and data store 220 are in communication over network 230. For example, network 230 can include any technically feasible network hardware suitable for allowing two or more computing devices to communicate with each other and/or to access distributed or remote data storage devices, such as data store 220.

Computing device 240 shown herein is for illustrative purposes only, and variations and modifications in the design and arrangement of computing device 240, without departing from the scope of the present disclosure. In some examples, computing device 240 includes an architecture consistent with the architecture of system 100. For example, the number of processors 242, the number of and/or type of memories 244, and/or the number of applications and or data stored in memory 244 can be modified as desired. In some embodiments, any combination of processor(s) 242 and/or memory 244 can be included in and/or replaced with any type of virtual computing system, distributed computing system, and/or cloud computing environment, such as a public, private, or a hybrid cloud system.

Each of processor(s) 242 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processors 242 can be any technically feasible hardware unit capable of processing data and/or executing software applications. During operation, processor(s) 242 can receive user input from input devices (not shown), such as a keyboard or a mouse.

Memory 244 of computing device 240 stores content, such as software applications and data, for use by processor(s) 242. As shown, memory 244 includes, without limitation, design generation application 246, performance metrics 258, and design examples 256. Memory 244 can be any type of memory capable of storing data and software applications, such as a random-access memory (RAM), a read-only memory (ROM), an erasable programmable read-only memory (EPROM or Flash ROM), or any suitable combination of the foregoing. In some embodiments, additional storage (not shown) can supplement or replace memory 244. The storage can include any number and type of external memories that are accessible to processor(s) 242. For example, and without limitation, the storage can include a Secure Digital Card, an external Flash memory, a portable CD-ROM, an optical storage device, a magnetic storage device, and/or any suitable combination of the foregoing.

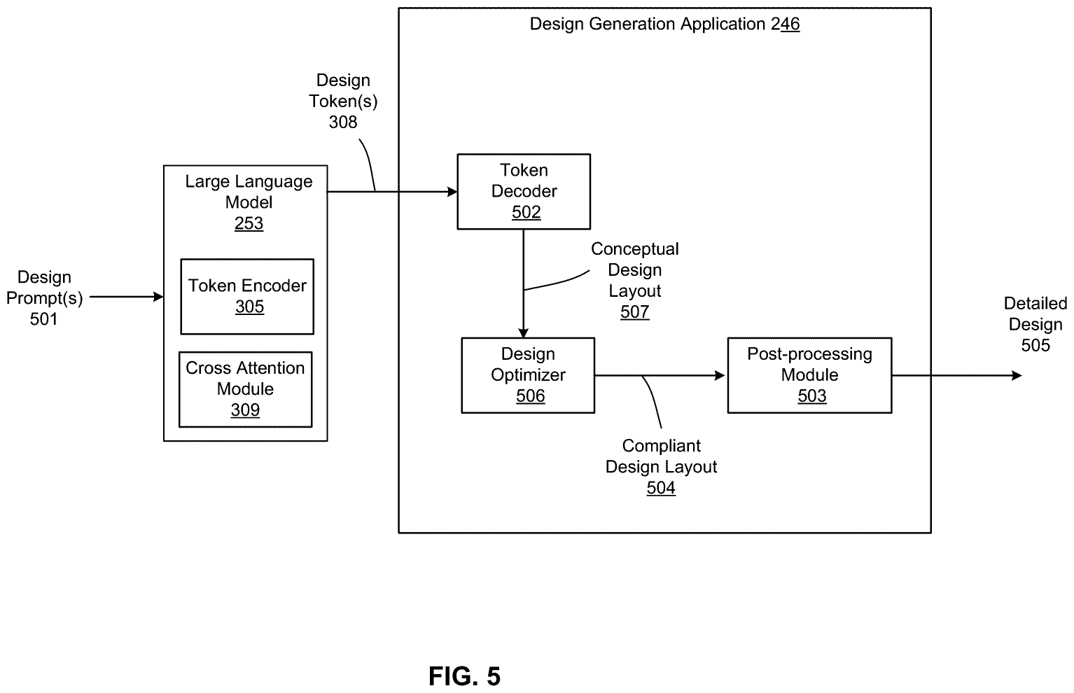

As shown, design generation application 246 is stored in memory 244 and executes on processor(s) 242. Design generation application 246 receives one or more design prompts from a user via one or more I/O device(s) (not shown). Based on the one or more design prompts, design generation application 246 uses large language model 253 to generate candidate designs. Design generation application 246 then uses design examples 256 and performance metrics 258 to refine and optimize the candidate designs to generate corresponding design layouts that meet various requirements and constraints. Design examples 256 are used to ensure candidate design layouts comply with design constraints and standards by providing reference design layouts that, for example, embody desirable features and adherence to regulations. Performance metrics 258, such as entropy, are used to evaluate and enhance the quality and diversity of the generated design layout. Design generation application 246 is discussed in greater detail below in conjunction with FIGS. 5, 6A-6C and FIGS. 9-10.

FIG. 3 is a more detailed illustration of model trainer 215 of FIG. 2, according to various embodiments. As shown, model trainer 215 includes, without limitation, a design generation module 301 and a large language model trainer 310. Design generation module 301 includes, without limitation, a design orchestrator 303 and design optimizer 302. Large language model 253 includes, without limitation, a text encoder 305 and a cross attention module 309. In operation, design generation module 301 generates design layouts 306 and attributes 307 which are stored as design data 304. Token encoder 305 included in large language model 253 encodes design layouts 306 into design tokens 308. Cross attention module 309 integrates design tokens 308 and attributes 307 and then large language model trainer 310 trains large language model 253.

Design generation module 301 generates design data 304 used for training large language model 253. Design generation module 301 generates design layouts 306 and then determines associated attributes 307 that capture various performance metrics and design constraints. Design generation module 301 uses various algorithms to generate design data 304, which is diverse and high-quality. Design generation module 301 includes design orchestrator 303 and design optimizer, which interact to generate design layouts 306 and attributes 307.

In architectural designs, design layouts 306 can include detailed architectural plans that specify the spatial arrangement of different elements, such as buildings, parks, and/or the like. In industrial designs, design layouts 306 can detail the configuration of machinery, workstations, safety zones within a manufacturing facility, and/or the like. In graphic design, design layouts 306 can outline the composition of visual elements on a webpage, poster, or advertisement, including the placement of images, text, interactive elements, and/or the like. In automotive design, design layouts 306 can specify the arrangement of components within a vehicle, such as the positioning of the engine, seating, cargo space, and/or the like. In various embodiments, design layouts 306 are represented as grids composed of tiles, where each tile corresponds to a specific type of space or design element, such as street, park, and/or the like.

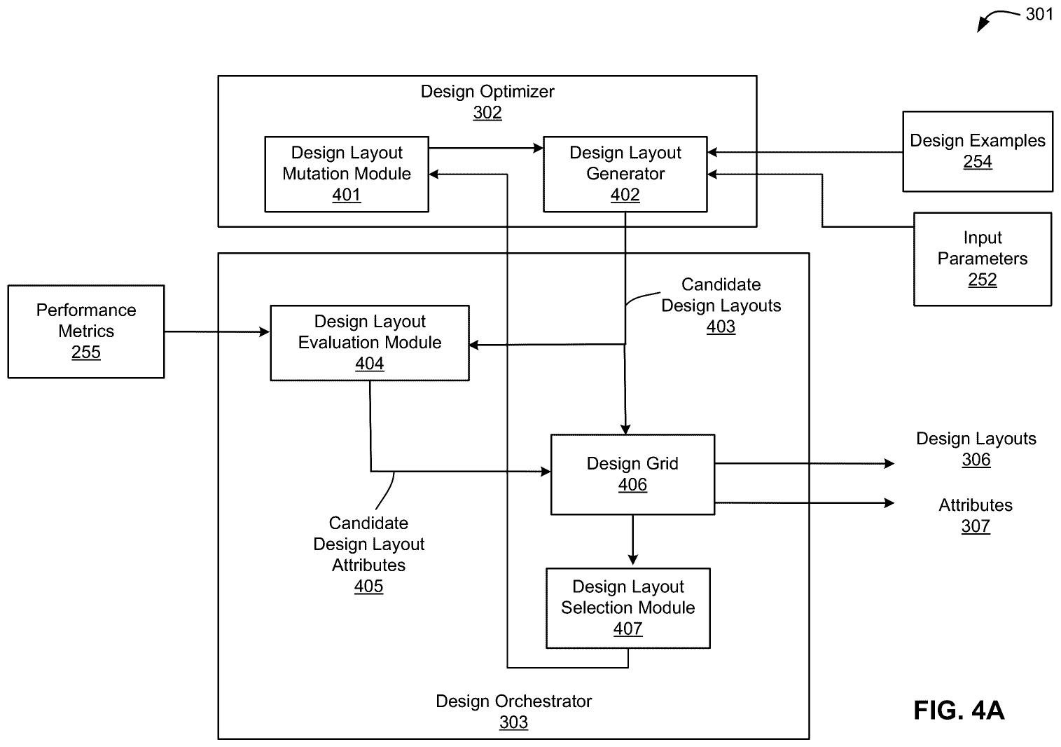

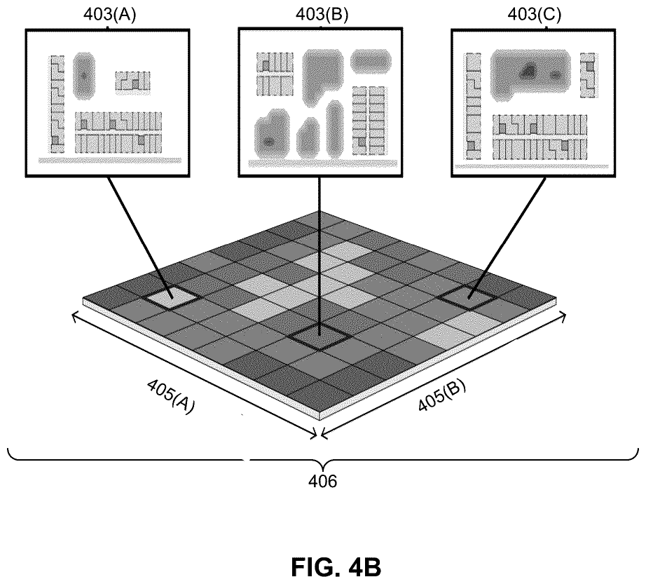

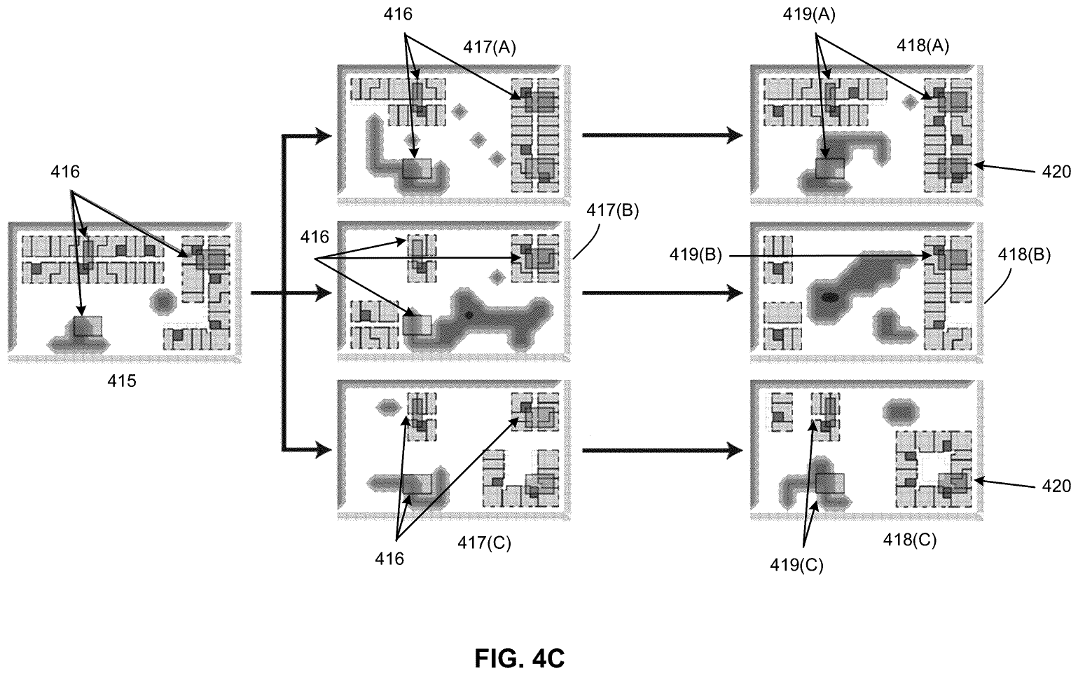

Attributes 307 provide a set of descriptive metrics and characteristics for each design layout 306. For example, in architectural designs, attributes 307 include but are not limited to environmental impact metrics, such as one or more of carbon sequestration, space utilization efficiency, compliance with zoning laws, aesthetic appeal, and other performance metrics, such as cost estimates, construction feasibility, and/or the like. For example, a design layout can outline a new urban park with designated areas for playgrounds, green spaces, and walking paths, while the attributes can detail the expected carbon sequestration from the planted trees, the percentage of the area dedicated to recreational use, and the alignment with local zoning regulations. Design generation module 301 is discussed in greater detail in conjunction with FIG. 4A. The generated design layouts 306 and the corresponding attributes 307 are stored as design data 304.

Large language model 253 includes, without limitation, a token encoder 305 and cross attention module 309. Token encoder 305 encodes design layouts 306 into design tokens 308. Design tokens 308 are in a standardized format that large language model 253 can process. Token encoder 305 encodes design layouts 306 in various ways, including but not limited to categorizing multiple tiles states into a more manageable set of design tokens 308. For example, a design layout can include hundreds of specific cell configurations, each with corresponding adjacency rules and spatial relationships. Each specific configuration is grouped into broader token categories, such as ‘EMPTY,’ ‘STREET,’ ‘GROUND,’ ‘CORE,’ ‘CORRIDOR,’ ‘END,’ ‘MIDDLE,’ ‘SIDE’, and/or the like. For example, a ‘GROUND’ cell can represent various types of ground-level spaces, including but not limited to gardens, plazas, or courtyards, while a ‘CORE’ cell can include structural elements, such as stairwells, elevators, and/or the like. By encoding design layouts 306 into design tokens 308, token encoder 305 simplifies the design layout representation and allows large language model 253 to focus on higher-level design principles rather than the details of individual tile relationships. In various embodiments, design tokens 308 are associated with high-level natural language descriptions, such as ‘few/some/many parks’ by large language model 253. In at least one embodiment, large language model 253 generates a conceptual design layout by predicting a single tile in the conceptual design layout based on a sequence of previously generated tiles. In some examples, large language model 253 uses a distilled version of GPT-2 called DistilGPT2, with 96 million trainable parameters which can be trained efficiently on a single GPU.

Cross attention module 309 integrates design tokens 308 and attributes 307. Cross attention module 309 uses a cross-attention mechanism to align sequences of design tokens 308 generated by large language model 253 in the inference step with specific attributes 307 from the training design data 304 examples. The cross-attention mechanism helps large language model 253 learn to associate certain design tokens 308, quantities of design tokens 308, and/or placement/order of design tokens 308 in the sequence with the corresponding attributes 307. For example, environmental sustainability attributes, such as carbon sequestration potential, directly influence the placement and type of green spaces within the design layout. If attributes 307 emphasize high carbon sequestration, cross attention module 309 emphasizes design token 308 selection to include more parks, green roofs, and/or the like.

Large language model trainer 310 trains and fine-tunes large language model 253 to generate conceptual design layouts using sequences of design tokens 308. In various embodiments, large language model trainer 310 uses a process, known as “next tile prediction,” which is analogous to the “next token prediction” objective used in most causal language models. In at least one embodiment, large language model trainer 310 uses additional cross-attention weights to include design prompts by using a frozen text encoder, such as Bidirectional and Auto-Regressive Transformers (BART), which converts design prompts into numerical vectors. The numerical vectors represent high-level design objectives or constraints, such as “many parks” or “high carbon sequestration.” The numerical vectors are averaged and included in the cross-attention weights, allowing large language model 253 to select the design tokens 308 in generated conceptual design layouts consistent with the specified attributes. In various embodiments, during training, large language model trainer 310 uses the context of previously generated design tokens 308 to predict the next design token 308. For example, if the design prompt(s) specify a design with “many parks,” large language model trainer 310 trains large language model 253 to generate a sequence of design tokens 308 that includes green spaces, ensuring that the overall conceptual design layout adheres to the design prompt. During training, large language model trainer 310 repeatedly samples random sets of design layouts 306, typically in batches—for example, 16 design layouts per batch. Large language model trainer 310 provides the samples to large language model 253, which then predicts the next design token 308 in the sequence. Large language model trainer 310 evaluates the predictions against the actual design layouts to compute a loss function, which reflects the accuracy of the predictions of large language model 253. Based on the loss, large language model trainer 310 optimizes the parameters of large language model 253 using an optimization algorithm, such as the Adam optimizer. Large language model trainer 310 continues training large language model 253 until a specified end condition is met, such as reaching 500,000 training steps or achieving a target performance metric.

FIG. 4A is a more detailed illustration of design generation module 301 of FIG. 3, according to various embodiments. As shown, design optimizer 302 includes, without limitation, a design layout mutation module 401 and a design layout generator 402. Design orchestrator 303 includes, without limitation, a design layout evaluation module 404, a design grid 406, and a design layout selection module 407. In operation, design layout generator 402 receives input parameters 252 and design examples 254 to generate initial candidate design layouts 403. Design layout evaluation module 404 evaluates candidate design layouts 403 using performance metrics 255 to generate candidate design layout attributes 405. The evaluated candidate design layouts 403 and the corresponding candidate design layout attributes 405 are stored in design grid 406. Design layout selection module 407 then selects high-performing and diverse candidate design layouts 403 from design grid 406. Design layout mutation module 401 mutates the selected candidate design layouts to explore a broader design layout space. The resulting candidate design layouts 403 are iteratively further optimized, ultimately generating design layouts 306 and the corresponding attributes 307.

Design layout generator 402 receives design examples 254 and input parameters 252 and generates candidate design layouts 403. Design layout generator 402 uses input parameters 252 to generate initial candidate design layouts 403 that comply with the constraints inferred from design examples 254. In at least one embodiment, the Wave Function Collapse (WFC) algorithm, which generates a wide array of unique candidate designs layouts 403 from design examples 254, is used to generate candidate design layouts 403. The WFC algorithm is a procedural content generation technique for creating multi-dimensional, for example, 2D and 3D, design layouts using a constraint satisfaction algorithm. The algorithm works through iterations of a single tile collapse, where a tile is assigned to a fixed state, and neighborhood propagation, where surrounding tiles are constrained to compatible patterns with the collapsed tile. The WFC algorithm operates in several steps: (1) Pattern Extraction: WFC starts by analyzing one or more self-similar design examples 254 to identify tile adjacencies. The adjacencies form a domain of possible constrained states for each tile. (2) Initialization and Pre-Constraint: The design layout is initialized with each tile represented as an array of potential states. One or more tiles are then selected randomly or deterministically and collapsed to a known state to “seed” the process. Tiles can also be pre-constrained to a subset of states to enforce boundary conditions or ensure controlled generation from an initial pattern. (3) Tile Collapse: The tile with the lowest entropy (least uncertainty) is selected for collapse. Tiles are collapsed in order of minimum entropy, measured as the certainty of a specific outcome from the weightings of potential states, precisely defined as:

$$Shannon Entropy = log ( \sum {w}_{i} ) - \frac{\sum ( {w}_{i} \times log ( {w}_{i} ) )}{\sum {w}_{i}} \qquad ( Equation 1 )$$

where wᵢ represents the weight of each potential state for a tile. The weight reflects the likelihood or frequency of a particular state occurring based on the adjacency constraints and the neighbors. From the possible states of the selected tile, a single state is chosen using weighted random selection, and all other potential states are discarded. If multiple tiles have the same lowest entropy value, one is chosen randomly. (4) Propagation: After collapsing a tile, the WFC algorithm iterates through adjacent tiles and removes all pattern states a single tile or a contradiction arises, indicating that the solver cannot satisfy all constraints. When a contradiction occurs, the WFC algorithm backtracks to a previous state and revises the choices made, which includes but is not limited to re-evaluating the previous tile collapses and selecting alternative states for the tiles that led to the contradiction. The WFC algorithm then attempts to collapse the tiles again, using the new choices to ensure that all constraints are satisfied. The backtracking and revision process continues until a valid arrangement of tiles is found or it is determined that no valid arrangement of tiles is possible under the given constraints. If no valid arrangement of tiles is possible under the given constraints, the WFC algorithm restarts with a different initial arrangement of tiles or adjusts the constraints, ensuring the search for a valid arrangement of tiles continues. In some embodiments, Each tile in a candidate design layout corresponds to basic tile type that can be mapped to one or more specific tile types that can be included in a design layout.

Design layout evaluation module 404 uses performance metrics 255 to evaluate candidate design layouts 403 and generate candidate design layout attributes 405. Performance metrics 255 include various quantitative and qualitative measures that assess the quality of the candidate design layouts 403. Performance metrics 255 can include environmental sustainability (e.g., carbon sequestration potential), space efficiency (e.g., usable square footage), compliance with local zoning regulations (e.g., building height restrictions), cost estimates, construction feasibility, and aesthetic appeal. For example, a candidate design layout for an urban park can be evaluated based on the total green space provided, the expected reduction in urban heat islands, and the candidate design layout's alignment with community planning regulations. For an industrial candidate design layout, performance metrics 255 can include material usage efficiency, manufacturability, and ergonomic considerations. Based on the evaluations, design layout evaluation module 404 generates candidate design layout attributes 405, which provide a detailed description of each candidate design layout's performance across the various performance metrics 255.

Design grid 406 includes candidate design layouts 403 and the candidate design layout attributes 405. In various embodiments, design grid 406 organizes candidate design layouts 403 based on the corresponding candidate design layout attributes 405. Each cell in design grid 406 represents a unique combination of attribute values, ensuring that a diverse range of design layout solutions is explored. Design grid 406 facilitates the comparison and selection of the best candidate design layouts by design layout selection module 407 by highlighting candidate design layouts 403 that perform well across various performance metrics 255. For example, in the context of urban planning, design grid 406 can include candidate design layouts 403 with different proportions of green space, varying building heights, and different configurations of public amenities. In industrial design, design grid 406 can organize candidate design layouts 403 based on material efficiency, ease of assembly, and ergonomic factors.

Design layout selection module 407 selects several candidate design layouts from design grid 406. In various embodiments, design layout selection module 407 uses a genetic algorithm to evaluate and select candidate design layouts 403 based on the candidate design layout attributes 405 for the cells in design grid 406. Design layout selection module 407 evaluates candidate design layouts 403, identifies candidate design layouts 403 that exhibit high performance and diversity, and selects a diverse set of high-performing candidate design layouts 403. In at least one embodiment, by focusing on a diverse set of high-performing designs, design layout selection module 407 explores a broad candidate design layout 403 solution space, preventing convergence on suboptimal design layouts. For example, in architectural design, design layout selection module 407 can prioritize candidate design layouts 403 with candidate design layout attributes 405 that maximize green space while adhering to zoning laws and minimizing construction costs. In automotive design, design layout selection module can select candidate design layouts 403 with candidate design layout attributes 405 that enhance aerodynamic efficiency, passenger comfort, and manufacturing feasibility.

Design layout mutation module 401 mutates the selected candidate design layouts selected by design layout selection module 407. In various embodiments, design layout mutation module 401 sets the selected candidate design layouts as the parent design layouts. In some embodiments, design layout mutation module 401 encodes a genome composed of fixed tiles and tile weights. Fixed tiles, which represent specific parts of the parent design layout, are included in the genome, and passed on to child design layouts. Including fixed tiles in the genome and passing the fixed tiles to child design layouts ensures that small changes in the genotype produce small, predictable changes in the phenotype. The more tiles that are fixed, the narrower the distribution of possible mappings from genotype to phenotype. In various embodiments, design layout mutation module 401 further instantiates individuals by including a random seed, ensuring that a given genome always produces the same phenotype. The resulting genotype is represented as a tuple comprising tile weights, fixed tiles, and a seed:

$$Genotype = ( {T}_{weight} , {T}_{fixed} , Seed ) \qquad ( Equation 2 )$$

where, T_{weight} is a vector of tile weights, T_{fixed} is a list of tuples with each tuple representing a tile type and the position of the tile in design grid 406. In some examples, design layout mutation module 401 uses a mutation operator for solution search, which involves the following steps: (1) For example, the T_{weight} vector can be modified by the addition of Gaussian noise, adjusting the weights either upward or downward, (2) Tiles are added or removed from the T_{fixed} list. (3) Seed is reset to a new random integer. At each generation an equal number of individuals are chosen to have tiles removed and added. Tiles are chosen to be added or removed randomly, and the number added or removed is drawn, for example, from a uniform distribution between 1 and 4 tiles. In some embodiments, fixed tiles are added from the phenotype of the parent solution. In at least one embodiment, design layout mutation module 401 uses iterative adding and removing of tiles to search through the space of design layouts.

Design layout generator 402 uses the mutated genotypes, design examples 254, and input parameters 252 to generate new candidate design layouts 403. Each genotype, which includes of a vector of tile weights, a list of fixed tiles, and a random seed, guides the creation of new candidate design layouts 403. In various embodiments, the tile weights influence the probability of each tile being chosen during the execution of the WFC algorithm by design layout generator 402. The fixed tiles retain specific elements of the parent design layout in the new design layout. During generation, the WFC algorithm starts with the fixed tiles and uses the tile weights to probabilistically determine the placement of the remaining tiles, adhering to the design constraints and maintaining the characteristics defined by the genotype. The random seed maintains consistency in the generation, producing the same phenotype for a given genotype. The new candidate design layouts 403 are evaluated by design layout evaluation module 404 based on performance metrics 255 to generate new candidate design layout attributes 405. Design orchestrator 303 then updates design grid 406 with the new candidate design layouts 403 and the new candidate design layout attributes 405. In various embodiments, design orchestrator 303 replaces older candidate design layouts 403 with new candidate design layouts 403 in design grid 406 when the new candidate design layouts 403 have superior performance based on performance metrics 255. The iterative process of selection, mutation, generation, and evaluation continues until a specified number of generations is reached or an optimization criterion, such as achieving a target convergence metric and/or the like, is met.

FIG. 4B illustrates an example set of candidate design layouts 403 in a design grid 406, according to various embodiments. As shown, each cell in design grid 406 corresponds to a specific candidate design layout 403(A), 403(B), and 403(C). Each candidate design layout 403(A)-403(C) is an example of a candidate design layout with a specific configuration of elements, such as buildings, parks, and/or the like. Design grid 406 is divided into multiple dimensions, represented by 405(A) and 405(B), which categorize the design layouts based on different candidate design attributes 405, for example, carbon sequestration, number of units, and/or the like. For example, if 405(A) represents carbon sequestration potential, and 405(B) represents the number of residential units, design layout 403(A) can be an example of a design layout with low carbon sequestration and a low number of units, such as a design that features minimal green spaces and fewer buildings. Design layout 403(B) can represent a design layout with low carbon sequestration but a higher number of units, indicating a design layout with dense building arrangements and limited green spaces. Conversely, design layout 403(C) could illustrate a layout with both high carbon sequestration and a high number of units, exemplifying a design that optimizes green spaces, such as parks and green roofs, alongside a significant number of residential units.

FIG. 4C illustrates the mutation process of an example selected candidate design layout according to various embodiments. Initially, design layout mutation module 401 selects fixed tiles 416 from parent candidate design layout 415 and includes fixed tiles 416 in the genome to guide the generation of new candidate design layouts. Design layout mutation module 401 creates multiple initial candidate design layouts 417(A), 417(B), and 417(C) from parent candidate design layout 415, incorporating the fixed tiles 416. Next, design layout mutation module 401 mutates the initial candidate design layouts 417(A), 417(B), and 417(C) to create new candidate design layouts 418(A), 418(B), and 418(C), respectively. In various embodiments, design layout mutation module 401 modifies the tile weights with Gaussian noise and resets the random seed, generating variations in the new candidate design layouts while maintaining adherence to the fixed tiles 416 from the parent candidate design layout 415. The mutation process allows for exploring a diverse set of candidate design layouts by repeatedly adding, removing, and altering tiles, ensuring that new candidate design layouts are varied while still following the guidelines and requirements derived from parent design layout 415. For example, in candidate design layout 418(A), design layout mutation module 401 adds a new fixed tile 420 while keeping tiles 419(A) unchanged from the original fixed tiles 416. In 418(B), two of the fixed tiles from 416 are removed, resulting in only the fixed tile 419(B). In 418(C), design layout mutation module 401 both adds fixed tile 420 and removes a fixed tile from fixed tiles 416, keeping fixed tiles 419(C) from fixed tiles 416. Additionally, design layout generator 402 uses the WFC algorithm on the mutated candidate design layouts 417(A), 417(B), and 417(C) to collapse tiles into new configurations, resulting in changes in other parts of the design layouts 417(A)-417(C).

FIG. 5 is a more detailed illustration of the design generation application 246 of FIG. 2, according to various embodiments. As shown, design generation application 246 includes, without limitation, a token decoder 502, a design optimizer 506, and a post-processing module 503. In operation, the trained large language model 253 receives design prompt(s) 501 and generates design token(s) 308. Design generation application 246 processes design token(s) 308 and generates detailed design 505.

Design prompt(s) 501 are provided as natural language inputs to large language model 253. For example, for architectural design, design prompt(s) 501 can include “Create a residential building with at least 20% green space and rooftop gardens”, “Design an urban park that maximizes carbon sequestration and includes playgrounds, walking paths, and a water feature”, or “Generate a layout for a commercial complex with integrated solar panels and high energy efficiency”. In automotive design, one or more design prompt(s) 501 can include “Design an electric vehicle that prioritizes aerodynamic efficiency and includes ample cargo space”, “Create a sports car with a sleek, modern aesthetic and high-performance capabilities”, or “Generate a family SUV with maximum passenger comfort and advanced safety features”. In graphic design, one or more design prompt(s) 501 can include “Design a minimalist poster for a music festival with vibrant colors and clear typography”, “Create a logo for a tech startup that conveys innovation and reliability”, or “Generate a magazine cover that captures the essence of modern fashion trends” In various embodiments, for design prompt(s) 501 not provided, design generative application 246 generates randomly sampled prompts for each of the attributes on which large language model 253 was trained, but were not mentioned in design prompt(s) 501.

Large language model 253 processes design prompt(s) 501 and generates design token(s) 308. One or more design prompt(s) 501 are converted to a vector of tokens by the token encoder 305 and used as a constant input to the cross attention module 309. Then, large language model 253 engages in an iterative process to generate design token(s) 308. The iterative process includes large language model 253 predicting the next design token 308 based on the sequence of previously generated tokens. The cross attention module 309 aligns the design tokens with the attributes derived from the training design data 304 examples and the attributes identified by the vector of tokens encoded from design prompt(s) 501, ensuring that each new design token 308 is contextually appropriate with the previous design token(s) 308 and the design prompt(s) 501.

Token decoder 502 processes design token(s) 308 and generates conceptual design layout 507. Conceptual design layout 507 is a high-level representation that outline the spatial arrangement and elements based on the design token(s) 308. For example, in an architectural design context, conceptual design layout 507 can indicate the placement of buildings, green spaces, and pathways, providing a preliminary structure that meets the requirements specified in design prompts 501. In automotive design, conceptual design layout 507 can outline the general shape and layout of a vehicle, including major components such as the engine, passenger cabin, cargo space, and/or the like. In some embodiments, token decoder 502 maps design token(s) 308 to the corresponding physical or functional counterparts within a design layout. In at least one embodiment, token decoder 502 applies learned patterns and rules from the training design data 304 to arrange the tile elements logically and aesthetically, ensuring that the resulting conceptual design layout 507 aligns with the high-level design principles and constraints encoded in design token(s) 308. For example, in architectural design, design token(s) 308 representing green spaces, pathways, and buildings are decoded into specific locations and orientations, forming an initial blueprint that guides design optimizer 506. In various embodiments, the basic tile types included in design token(s) 308 are also transformed into a set of allowable tiles. For example, in an architectural design, a ‘building core’ can be represented in various possible orientations.

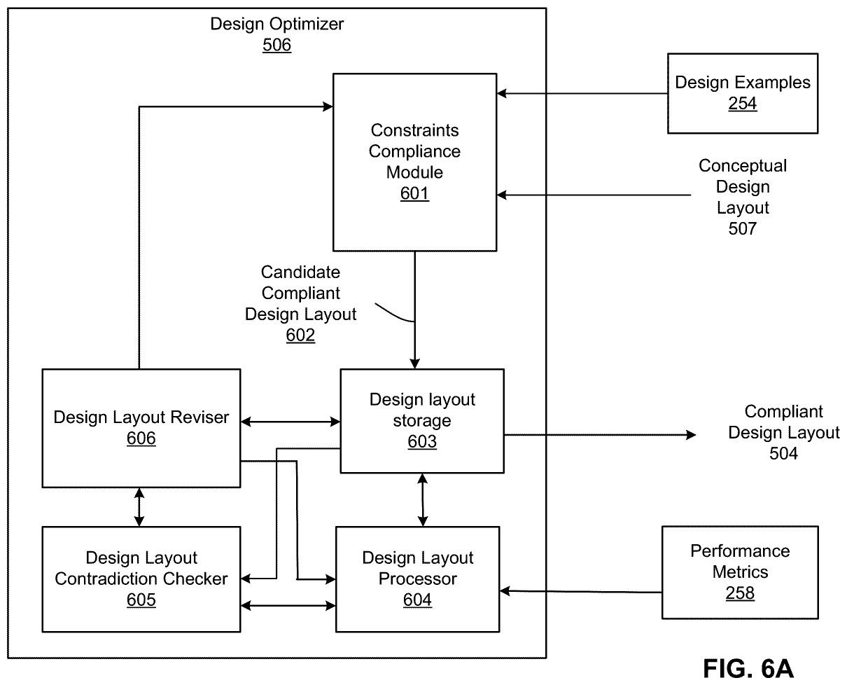

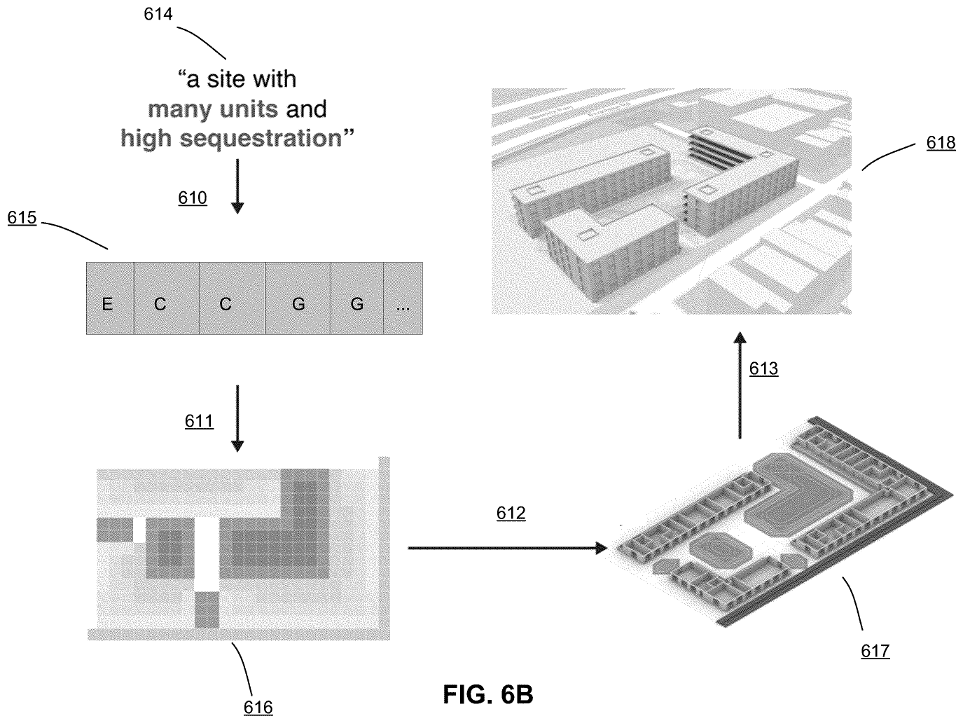

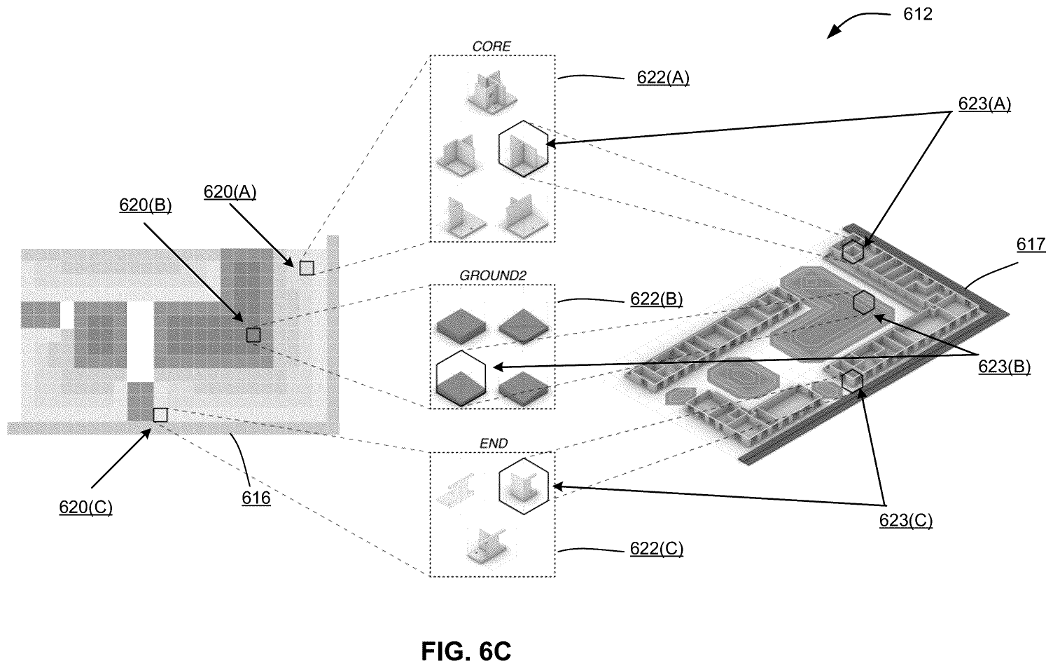

Design optimizer 506 processes conceptual design layout 507 and generates compliant design layout 504. In various embodiments, design optimizer 506 takes the initial blueprint included in conceptual design layout 507 and refines conceptual design layout 507 further to ensure compliance with specified constraints and requirements. Design optimizer 506 then processes the refined conceptual design layout 507 by selecting from a comprehensive tile-set to add details ensuring that the compliant design layout 504 not only meet the high-level requirements but also includes the detailed elements to be practical and functional. For example, in architectural designs, design optimizer 506 adds orientations, placement of windows, interior walls, and/or the like. Design optimizer 506 is described in more detail in conjunction with FIG. 6A. Compliant design layout(s) 504 is not only complete in structure but also compliant with the given constraints and ready for refinement to a higher level of detail.

Post-processing module 503 processes compliant design layout 504 and generates detailed design 505. In various embodiments, post-processing module 503 extrapolates compliant design layout 504 vertically to add layers of detail and structure. In some examples, detailed design 505 is then readily transferable to Building Information Modeling (BIM) software for further detailed editing and analysis, ensuring that detailed design 505 is practical and ready for implementation. For non-architectural design fields, equivalent platforms include but is not limited to Computer-Aided Design (CAD) software such as SolidWorks, CATIA, or AutoCAD for automotive design, CAD software and Product Lifecycle Management (PLM) tools like Siemens NX, PTC Creo, and Autodesk Inventor for industrial design, graphic design software such as Adobe Creative Suite (Photoshop, Illustrator, InDesign) or CorelDRAW for graphic design, and Geographic Information Systems (GIS) software such as ArcGIS or QGIS for urban planning design.

In various embodiments, users have the flexibility to modify detailed design 505 iteratively. For example, a portion of the site can be erased and re-generated by inputting alternative design prompt(s) 501, directing the design generation application 246 to refill the erased portion with a design that incorporates specific desired features. The iterative design modification capability enhances the adaptability and user interactivity of the generative design process, allowing for continuous refinement and customization of detailed design 505 to meet specific user requirements and preferences.

FIG. 6A is a more detailed illustration of the design optimizer 506 of FIG. 5, according to various embodiments. As shown, design optimizer 506 includes, without limitation, a constraints compliant module 601, a design layout storage 603, a design layout processor 604, a design layout contradiction checker 605, and a design layout revisor 606. Design optimizer 506 uses design examples 254 and performance metrics 258 to process conceptual design layout(s) 507 and generate compliant design layout(s) 504.

Constraints compliance module 601 uses design examples 254 to process conceptual design layout 507 and generates candidate compliant design layout 602. In at least one embodiment, constraints compliance module 601 uses design examples 254 and the WFC algorithm to process conceptual design layout 507 and generate candidate compliant design layout 602. The WFC algorithm starts by analyzing design examples 254 to identify tile adjacencies. The tile adjacencies form a domain of possible constrained states for each tile. Conceptual design layout 602 are initialized with each tile represented as an array of potential states. Then, conceptual design layout 507 is converted to WFC pre-constraints, which guide the pre-constraining of tiles to specific states. The WFC pre-constraints help enforce boundary conditions and ensure controlled generation from the initial pattern. The tiles are then selected randomly or deterministically and collapsed to a known state to “seed” the design optimization.

Design layout storage 603 stores candidate compliant design layout 602. Design layout storage 603 stores candidate compliant design layout 602 generated by constraints compliance module 601. In various embodiments, design layout storage 603 interacts with design layout processor 604 and stores the processed tiles of candidate compliant design layout 602. In at least one embodiment, design layout storage 603 interacts with design layout reviser 606 and stores the revised tiles of candidate compliant design layout 602 after revision by design layout reviser 606. Design layout storage 603 can be any type of memory, such as RAM, flash memory, hard drives, and/or the like.

Design layout processor 604 uses performance metrics 258 to process candidate compliant design layout 602 stored in design layout storage 603. In at least one embodiment, design layout processor 604 uses performance metrics 258, such as Shannon entropy in Equation 1, to select the tile with the lowest performance, such as a tile from among the tiles that have not been collapsed that has the lowest entropy, for collapse. A single state is chosen for the selected tile using weighted random selection, and all other potential states are discarded. If multiple tiles in design layout storage 603 have the same performance metric, such as lowest entropy value, one tile is chosen randomly. In various embodiments, after collapsing a tile, the WFC algorithm iterates through adjacent tiles and removes all pattern states incompatible with the collapsed tile. In some examples, design layout processor 604 uses the WFC algorithm to select from a tile-set to add details, such as orientations, the placement of windows, interior walls, and/or the like. Design layout processor 604 continues processing the tiles in candidate compliant design layout 602 stored in design layout storage 603 until all tiles collapse into a single state.

Design layout contradiction checker 605 interacts with design layout processer 604 to check whether a contradiction arises in candidate compliant design layout 602. In some embodiments, design layout contradiction checker 605 checks whether the WFC algorithm cannot satisfy all constraints for the given arrangement of tiles in candidate compliant design layout 602 stored in design layout storage 603. For example, when a tile no longer has any possible states, a contradiction occurs.

Design layout revisor 606 revises candidate compliant design layout 602. In at least one embodiment, when design layout contradiction checker 605 detects a contradiction in candidate compliant design layout 602, the WFC algorithm backtracks to a previous state and design layout revisor 606 revises the state choices made, such as re-evaluating previous tile collapses and selecting alternative states for the tiles that led to the contradiction. In various embodiments, design layout processor 604 then uses the WFC algorithm to collapse the tiles again using the new states. The backtracking and revision process continues until a valid arrangement of tiles in candidate compliant design layout 602 is found, or it is determined that no valid arrangement of tiles in candidate compliant design layout 602 is possible under the given constraints. If no valid arrangement is possible after revision by design layout reviser 606, constraints compliance module 601 generates a new candidate compliant design layout 602 with a different initial arrangement of tiles or adjusts the constraints to continue the search for compliant design layout 504.

Once all the tiles in candidate compliant design layout 602 are processed and no contradiction is detected by design layout contradiction checker 605, design optimizer 506 returns the compliant design layout(s) 504 from design layout storage 603.

FIG. 6B is an example illustration of the operation of design generation application 246 of FIG. 2, according to various embodiments. The design generation process begins with a design prompt 614, which is an example of one or more design prompt(s) 501, such as “a site with many units and high sequestration.” In process 610, design prompt 614 is used by large language model 253 to generate design tokens 615, which is an example of one or more design token(s) 308. For example, design tokens 615 can include tokens like “E” for EMPTY, “G” for GREEN, and “C” for CORRIDOR, representing different elements of a design layout. In process 611, token decoder 502 processes the design tokens 615 and generates the conceptual design layout 616, which is an example of conceptual design layout 507. Design tokens 615, representing abstract design elements, are decoded into a high-level design grid layout, forming the initial layout for the design. Conceptual design layout 616 is a preliminary layout that outlines the fundamental structure of the design, including but not limited to basic spatial arrangements and design elements without detailed specifications.

In process 612, constraints compliance module 601 included in design optimizer 506 processes the conceptual design layout 616 and generates candidate compliant design layout 602, which are stored in design layout storage 603. Design layout processor 604 then processes candidate compliant design layout 602 to ensure that candidate compliant design layout 602 meet the specified constraints and performance metrics. Design layout processor 604 uses various optimization algorithms, such as the WFC algorithm, to ensure compliant design layout 617 adheres to specified constraints and performance metrics. Design layout contradiction checker 605 checks whether there are any contradictions after candidate compliant design layout 602 is processed by design layout processor 604. If contradictions are detected, design layout revisor 606 revises compliant design layout 602. If design layout contradiction checker 605 detects contradictions after revision by design layout revisor 606. A new candidate compliant design layout 602 is generated and optimized by design optimizer 506. Design optimizer 506 then generates compliant design layout 617, which is an example of compliant design layout 504.

Compliant design layout 617 is more detailed and includes feasible plans that meet the design constraints and performance criteria, optimized for practical implementation. In process 613, post-processing module 503 processes compliant design layout 617 to generate detailed architectural design 618, which is an example of detailed design 505. In at least one embodiment, process 613 includes vertical extrapolation, where the compliant design layout 617 is extended upwards to add layers of detail and structure, and export into BIM software for further detailed editing and analysis. Detailed architectural design 618 includes fully developed plans ready for construction or manufacturing, containing the specifications, dimensions, and annotations.

FIG. 6C illustrates the optimization process 612 of an example conceptual design layout 616 to generate a corresponding compliant design layout 617, according to various embodiments. As shown, conceptual design layout 616 includes multiple basic tiles including tiles 620(A), 620(B), and 620(C) representing different sections of compliant design layout 617 and corresponding to a basic tile type. Each basic tile in the conceptual design layout 616 is mapped to a set of possible states 622(A)-622(C) by design optimizer 506 selected from the specific tile types that are possible based on the basic tile type for the corresponding tile 620(A), 620(B), or 620(C). For example, tile 620(A) corresponds to core design elements, which are translated into states 622(A) such as various configurations of stairwells and elevators. Similarly, tile 620(B) corresponds to ground-level elements, which are translated into states 622(B) such as different types of gardens and plazas. Tile 620(C) represents end elements, translated into states 622(C) such as various corridor end units. Design optimizer 506 processes tiles 620(A)-620(C) by selecting one of the states 623(A)-623(C) from 622(A)-622(C) to generate the compliant design layout 617. The selection of states is guided by performance metrics 258, which evaluate the suitability of each state based on one or more criteria such as spatial arrangement, environmental impact, compliance with regulatory requirements, and/or the like. Design layout processor 604 applies the WFC algorithm to collapse each tile to a specific state, such as 623(A)-623(C), which includes selecting the state with the lowest entropy from among the tiles that have not been collapsed, ensuring that the overall design layout progresses towards a compliant configuration. If a contradiction arises during this process, indicating that the current tile arrangement cannot satisfy the constraints, design layout contradiction checker 605 detects the contradiction. When a contradiction is detected, design layout revisor 606 backtracks to a previous state and re-evaluates the collapsed tiles, selecting alternative states from 622(A)-622(C) that can resolve the contradiction. The backtracking and revision process continues iteratively until a valid arrangement of tiles is found, or it is determined that no valid arrangement of tiles is possible under the given constraints. Once all tiles in 616 are successfully processed and no contradictions remain, the refined spatial arrangement of states 622(A), 622(B), and 622(C) are positioned within the compliant design layout 504 as 623(A), 623(B), and 623(C), respectively. The final compliant design layout 617 is then generated, meeting the specified design constraints and performance metrics.

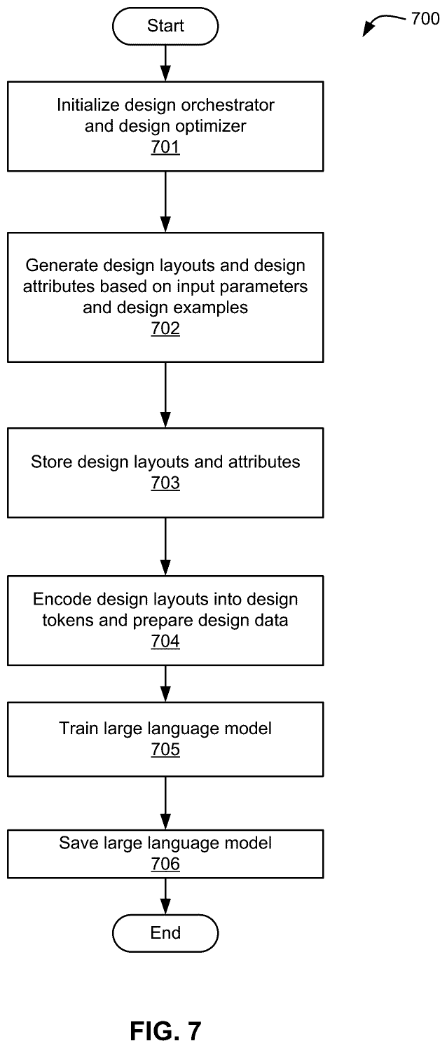

FIG. 7 sets forth a flow diagram of method steps for generating design data 304 and training large language model 253, according to various embodiments. Although the method steps are described in conjunction with the systems of FIGS. 1-4A, persons skilled in the art will understand that any system configured to perform the method steps in any order falls within the scope of the present disclosure.

The method 700 begins with step 701, where model trainer 215 initializes design orchestrator 303 and design optimizer 302. At step 701, design orchestrator 303 also receives input parameters 252 and design examples 254, which provide the initial constraints and guidelines for generating design layouts 306. In various embodiments, model trainer 215 initializes the parameters for the WFC algorithm and the grid size for design grid 406. For the WFC algorithm, parameters such as the pattern extraction method, entropy calculation, tile adjacency rules, and/or the like are initialized. Additionally, the grid size for design grid 406 is initialized, which defines the resolution and dimensions of the design layout space where candidate design layouts are generated and evaluated.

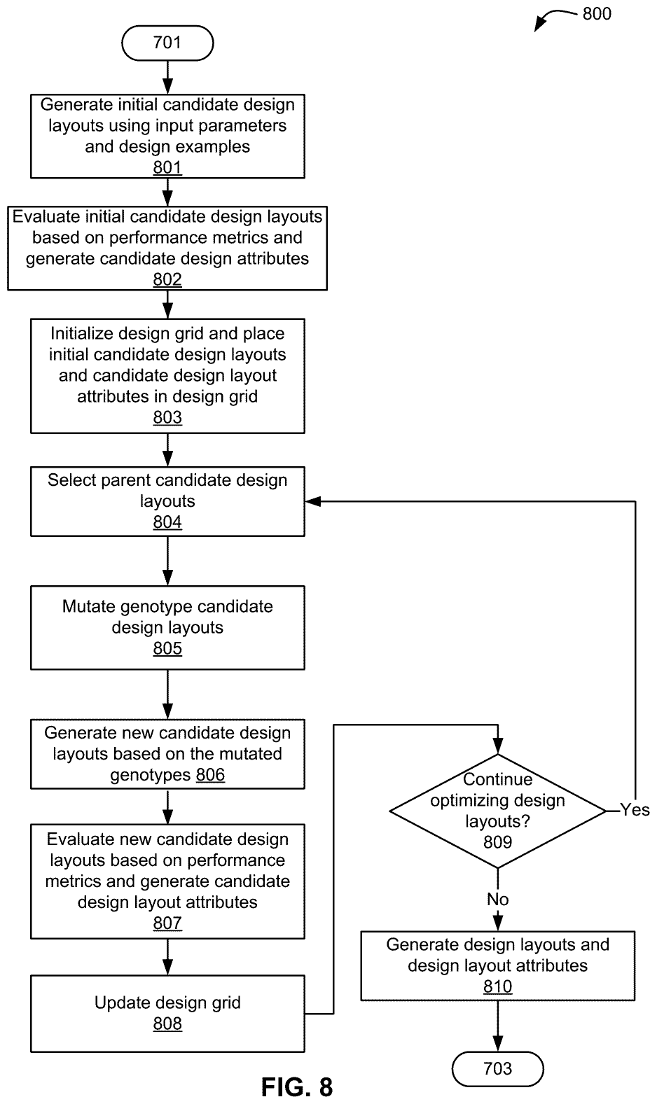

At step 702, design generation module 301 generates design layouts 306 and attributes 307 based on input parameters 252 and design examples 254. Design generation module 301 uses various algorithms including but not limited to MAP-Elites and WFC algorithms to generate and iteratively optimize candidate design layouts 306. Step 702 is described in further detail in conjunction with FIG. 8.

At step 703, design generation module 301 stores design layouts 306 and attributes 307 as design data 304. Design layouts 306 include various design fields. For example, in architectural designs, design layouts 306 can include detailed architectural plans specifying the spatial arrangement of different elements, such as buildings, parks, and green spaces. In industrial designs, design layouts 306 can detail the configuration of machinery, workstations, and safety zones within a manufacturing facility, ensuring high quality workflow and safety compliance. In graphic design, design layouts 306 can outline the composition of visual elements on various media, including webpages, posters, and advertisements. Design layouts 306 can specify the placement of images, text, and interactive elements to achieve a balanced and aesthetically pleasing design. In automotive design, design layouts 306 can specify the arrangement of components within a vehicle, such as the positioning of the engine, seating, and cargo space, optimizing for functionality and user comfort. Each design layout is represented as a grid composed of tiles, with each tile corresponding to a specific type of space or design element, such as streets, parks, or buildings. Attributes 307 provide descriptive metrics and characteristics for each design layout 306. For example, in architectural designs, attributes 307 can include environmental impact metrics such as carbon sequestration potential, space utilization efficiency, compliance with zoning laws, aesthetic appeal, cost estimates, and construction feasibility. A design layout can outline a new urban park with designated areas for playgrounds, green spaces, and walking paths, while the corresponding attributes can detail the expected carbon sequestration from planted trees, the percentage of the area dedicated to recreational use, and the alignment with local zoning regulations. In industrial designs, attributes 307 can include production efficiency, safety compliance, and operational costs. In graphic design, attributes 307 can include visual hierarchy, user engagement metrics, and brand alignment. In automotive design, attributes 307 can cover aerodynamics, fuel efficiency, passenger comfort, and safety ratings.

At step 704, large language model trainer 310 encodes design layouts 306 into design tokens 308 and prepares design data 304. The encoding process involves categorizing multiple tile states into a more manageable set of design tokens 308. For example, a design layout can include numerous specific cell configurations, each with corresponding adjacency rules and spatial relationships. The configurations can be grouped into broader token categories, such as ‘EMPTY,’ ‘STREET,’ ‘GROUND,’ ‘CORE,’ ‘CORRIDOR,’ ‘END,’ ‘MIDDLE,’ ‘SIDE,’ and similar categories. For example, a ‘GROUND’ tile can represent various types of ground-level spaces, including gardens, plazas, or courtyards, while a ‘CORE’ tile can include structural elements like stairwells and elevators.

At step 705, large language model trainer 310 trains large language model 253. Large language model trainer 310 trains and fine-tunes large language model 253 to generate conceptual design layouts using sequences of design tokens 308. During training, large language model trainer 310 samples random batches of design layouts 306, for example, 16 at a time, and provides the batch to large language model 253 for next-tile prediction. Large language model trainer 310 compares the predictions of large language model 253 against actual design layouts 306 to compute a loss function, which guides parameter optimization using optimization algorithms, such as the Adam optimizer. Large language model trainer 310 continues training large language model 253 until reaching predetermined goals, such as 500,000 steps or specific performance metrics.

At step 706, model trainer 215 saves large language model 253. Model trainer 215 stores the trained model parameters and configurations in data store 220, allowing for efficient retrieval and use in subsequent design generation processes. Once trained, large language model 253 can be deployed in any suitable manner, such as via a design generation application 246.

FIG. 8 sets forth a flow diagram of method steps for generating design layouts 306, according to various embodiments. Although the method steps are described in conjunction with the systems of FIGS. 2-4A, persons skilled in the art will understand that any system configured to perform the method steps in any order falls within the scope of the present disclosure. Method 800 describes method steps for generating design layouts 306 and attributes 307 in step 702 of method 700.

The method 800 begins with step 801, where design layout generator 402 generates initial candidate design layouts 403 based on input parameters 252 and design examples 254. Design layout generator 402 uses input parameters 252 to generate initial candidate design layouts 403 that comply with the constraints inferred from design examples 254. In at least one embodiment, design layout generator 402 uses WFC algorithm to generate initial candidate design layouts 403 from design examples 254. Design layout generator 402 begins by extracting patterns from design examples 254 to determine tile adjacencies and/or other constraints, which provide possible states for each tile. During the Initialization and Pre-Constraint phase, design layout generator 402 sets up each tile in design grid 406 with multiple potential states. Design layout generator 402 then selects and collapses specific tiles to seed candidate design layouts 403 according to predefined constraints. In some embodiments, design layout generator 402 selects the tile with the lowest entropy for collapse, simplifying the design by enforcing compatibility with adjacent tiles. If a contradiction emerges, indicating that the candidate design layout cannot satisfy all constraints, design layout generator 402 backtracks to adjust previous tile selections and tries to collapse again. Design layout generator 402 continues the cycle of selection, collapse, and adjustment until a valid tile arrangement is achieved in design grid 406, generating the initial candidate design layouts 403 that comply with the specified design constraints and the intended patterns from the design examples 254.

At step 802, design layout evaluation module 404 evaluates initial candidate design layouts 403 based on performance metrics 255 and generates candidate design attributes 405. Design layout evaluation module 404 uses performance metrics 255 to assess the quality of initial candidate design layouts 403. Performance metrics 255 include various quantitative and qualitative measures such as environmental sustainability (e.g., carbon sequestration potential), space efficiency (e.g., usable square footage), compliance with local zoning regulations (e.g., building height restrictions), cost estimates, construction feasibility, and aesthetic appeal. For example, a candidate design layout for an urban park can be evaluated on the total green space provided, the expected reduction in urban heat islands, and the alignment with community planning regulations. In industrial design, performance metrics 255 can include material usage efficiency, manufacturability, and ergonomic considerations. Based on the evaluations, design layout evaluation module 404 generates candidate design layout attributes 405, providing a detailed description of each initial candidate design layout's performance across the various performance metrics 255.

At step 803, design orchestrator 303 initializes design grid 406 and places initial candidate design layouts 403 and candidate design layout attributes 405 in design grid 406. Design grid 406 includes candidate design layouts 403 and the corresponding candidate design layout attributes 405. Design grid 406 organizes candidate design layouts 403 based on the corresponding candidate design layout attributes 405. Each cell in design grid 406 represents a unique combination of attribute values, ensuring that a diverse range of design layout solutions is explored. For example, in urban design, design grid 406 can include candidate design layouts 403 with different proportions of green space, varying building heights, and different configurations of public amenities. In industrial design, design grid 406 can organize candidate design layouts 403 based on material efficiency, ease of assembly, and ergonomic factors. The organization based on attributes enables a systematic comparison and selection process, facilitating the identification of high-performing design layouts that meet specified performance metrics 255.

At step 804, design layout selection module 407 selects parent candidate design layouts 403. In various embodiments, design layout selection module 407 uses a genetic algorithm to select candidate design layouts 403 from design grid 406 based on candidate design layout attributes 405, such as environmental sustainability, cost-effectiveness, regulatory compliance, and/or the like. The selection process includes assessing the performance and diversity of each candidate design layout. Design layout selection module 407 picks a diverse set of high-performing candidate design layouts 403, exploring a broad solution space and avoiding convergence on suboptimal designs.

At step 805, design layout mutation module 401 mutates genotype candidate design layouts 403. In various embodiments, design layout mutation module 401 sets the selected candidate design layouts as the parent design layouts. Design layout mutation module 401 encodes a genome composed of fixed tiles and tile weights. Fixed tiles, representing specific parts of the parent design layout, are included in the genome and passed on to child solutions. Including fixed tiles in the genome ensures that small changes in the genotype produce small, predictable changes in the phenotype. The more tiles that are fixed, the narrower the distribution of possible mappings from genotype to phenotype. In various embodiments, design layout mutation module 401 further instantiates individuals by including a random seed, ensuring that a given genome always produces the same phenotype. The resulting genotype is represented as a tuple comprising tile weights, fixed tiles, and a seed as described in Equation 2. In some examples, design layout mutation module 401 uses a mutation operator for solution search, which involves the following steps: (1) the tile weight vector is modified by the addition of Gaussian noise, adjusting the weights either upward or downward, (2) tiles are added or removed from the fixed tiles list, and (3) the seed is reset to a new random integer. Each time step 805 is performed, a number of individuals are chosen to have tiles removed and added. Tiles are chosen to be added or removed randomly, and the number added or removed is drawn from a uniform distribution, for example, a number between 1 and 4 tiles. In some embodiments, fixed tiles are added from the phenotype of the parent solution.

At step 806, design layout generator 402 generates new candidate design layouts 403 based on the mutated genotypes. Design layout generator 402 uses the mutated genotypes, design examples 254, and input parameters 252 to generate new candidate design layouts 403. Each genotype, which includes a vector of tile weights, a list of fixed tiles, and a random seed, guides the creation of new candidate design layouts 403.

At step 807, design layout evaluation module 404 evaluates new candidate design layouts 403 based on performance metrics 255 and generates candidate design layout attributes 405. Design layout evaluation module 404 uses performance metrics 255 to assess the quality of new candidate design layouts 403. Performance metrics 255 include various quantitative and qualitative measures such as environmental sustainability (e.g., carbon sequestration potential), space efficiency (e.g., usable square footage), compliance with local zoning regulations (e.g., building height restrictions), cost estimates, construction feasibility, and aesthetic appeal. For example, a candidate design layout for an urban park can be evaluated on the total green space provided, the expected reduction in urban heat islands, and the alignment with community planning regulations. In industrial design, performance metrics 255 can include material usage efficiency, manufacturability, and ergonomic considerations. Based on the evaluations, design layout evaluation module 404 generates candidate design layout attributes 405, providing a detailed description of each new candidate design layout's performance across the various performance metrics 255.

At step 808, design orchestrator 303 updates design grid 406. Design orchestrator 303 places the new candidate design layouts 403 generated by design layout generator 402 and the corresponding candidate design layout attributes 405 into the appropriate cells within design grid 406. In various embodiments, design orchestrator 303 replaces older candidate design layouts 403 with new candidate design layouts 403 when the new candidate design layouts 403 have superior performance based on performance metrics 255.

At step 809, design orchestrator 303 checks whether to continue optimizing design layouts 306. Design orchestrator 303 checks whether the optimization process has reached a specified number of generations or if an optimization criterion, such as achieving a target convergence metric, has been met. If neither condition is satisfied, the method 800 proceeds to the next iteration at step 804, with further evaluation, mutation, and generation of candidate design layouts 403. If the specified number of generations has been reached or the optimization criterion is met, the method 800 proceeds to step 810.

At step 810, design orchestrator 303 generates design layouts 304 and design layout attributes 307. The generated design layouts 306 and design layout attributes 307 are added to design grid 406.

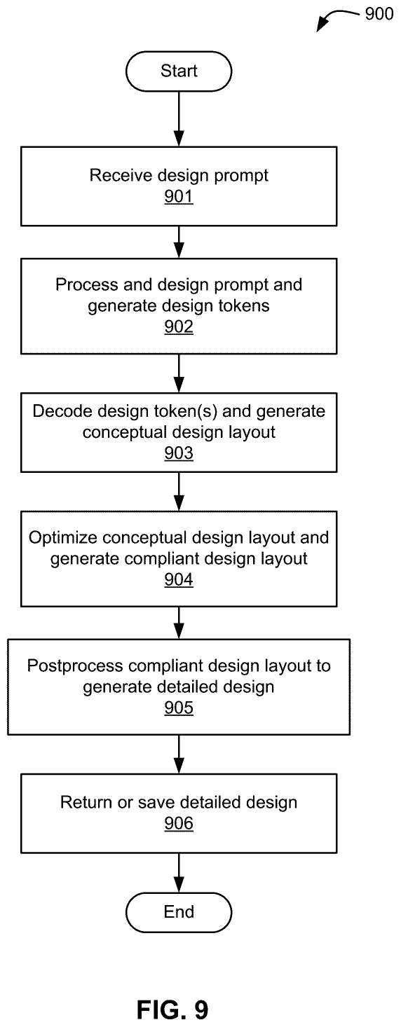

FIG. 9 sets forth a flow diagram of method steps for generating a detailed design 505, according to various embodiments. Although the method steps are described in conjunction with the systems of FIGS. 2, 5, and 6A, persons skilled in the art will understand that any system configured to perform the method steps in any order falls within the scope of the present disclosure.

The method 900 begins with step 901, where large language model 253 receives design prompt(s) 501. Design prompt(s) 501 are provided as natural language inputs to large language model 253. For example, in architectural design, one or more design prompt(s) 501 can include “Create a residential building with at least 20% green space and rooftop gardens,” “Design an urban park that maximizes carbon sequestration and includes playgrounds, walking paths, and a water feature,” or “Generate a layout for a commercial complex with integrated solar panels and high energy efficiency.” In automotive design, one or more design prompt(s) 501 can include “Design an electric vehicle that prioritizes aerodynamic efficiency and includes ample cargo space,” “Create a sports car with a sleek, modern aesthetic and high-performance capabilities,” or “Generate a family SUV with maximum passenger comfort and advanced safety features.” In graphic design, one or more design prompt(s) 501 can include “Design a minimalist poster for a music festival with vibrant colors and clear typography,” “Create a logo for a tech startup that conveys innovation and reliability,” or “Generate a magazine cover that captures the essence of modern fashion trends.” In various embodiments, for design prompt(s) not provided, design generative application 246 generates randomly sampled prompts for each of the attributes on which large language model 253 was trained but were not mentioned in design prompt(s) 501.

At step 902, large language model 253 processes design prompt 501 and generates design tokens 308. In various embodiments, large language model 253 converts design prompt 501 to a vector of tokens using token encoder 305, which is then used as a constant input to cross attention module 309. In various embodiments, large language model 253 engages in an iterative process, predicting the next design token 308 based on the sequence of previously generated design tokens 308. Cross attention module 309 aligns design tokens 308 with attributes derived from the training design data 304 examples and the attributes identified by the vector of tokens encoded from design prompt 501.

At step 903, token decoder 502 decodes design tokens 308 and generates conceptual design layout 507. Token decoder 502 processes design tokens 308 to create high-level representations included in conceptual design layout 507 that outline the spatial arrangement and elements based on design tokens 308. For example, in architectural design, conceptual design layout 507 can indicate the placement of buildings, green spaces, pathways, and/or the like, providing a preliminary structure meeting the requirements specified in design prompt 501. In automotive design, conceptual design layout 507 can outline the general shape and layout of a vehicle, including but not limited to major components such as the engine, passenger cabin, and cargo space. Token decoder 502 maps design tokens 308 to corresponding physical or functional counterparts within a design layout, applying learned patterns and rules from training design data 304 to arrange tile elements logically and aesthetically. Additionally, basic tile types included in design token 308 are transformed into a set of allowable tiles.

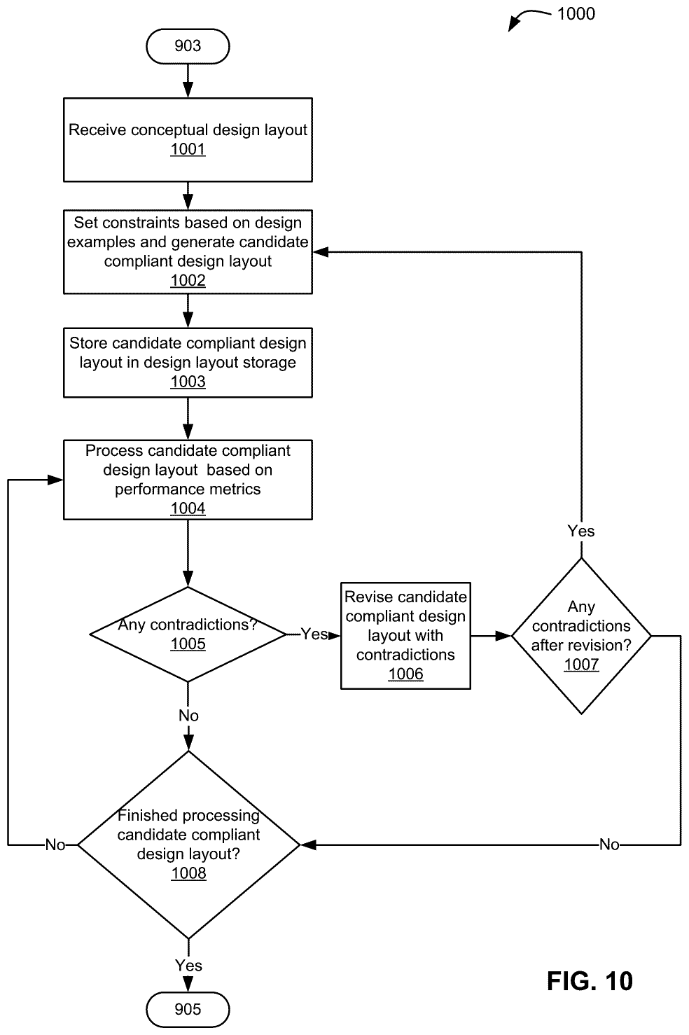

At step 904, design optimizer 506 optimizes conceptual design layout 507 and generates compliant design layout 504. Design optimizer 506 optimizes the initial blueprint provided in conceptual design layout 507 to meet specified constraints and requirements. In some embodiments, design optimizer 506 selects from a tile-set to add details, making compliant design layout 504 practical and functional. For example, in architectural designs, design optimizer 506 adds details, such as the orientations and placement of windows and interior walls. Design optimizer 506 generates compliant design layout 504 that are complete in structure, compliant with given constraints, and ready for further processing to a higher level of detail. Step 904 is described in further detail in conjunction with FIG. 10.

At step 905, post-processing module 503 processes compliant design layout 504 to generate detailed design 505. In some embodiments, post-processing module 503 vertically extrapolates compliant design layout 504 to add layers of detail and structure. In some examples, detailed design 505 are then made ready for transfer to BIM software for further detailed editing and analysis. For non-architectural design fields, equivalent platforms include but are not limited to CAD software such as SolidWorks, CATIA, or AutoCAD for automotive design; CAD software and PLM tools like Siemens NX, PTC Creo, and Autodesk Inventor for industrial design; graphic design software such as Adobe Creative Suite (Photoshop, Illustrator, InDesign) or CorelDRAW for graphic design; and GIS software such as ArcGIS or QGIS for urban planning design. Detailed design 505 are practical and ready for implementation.

At step 906, design generation application 246 returns or saves detailed design 505. In various embodiments, design generation application 246 stores detailed design 505 in data store 220 or returns detailed design 505 to the user through an appropriate display device, such as 110. In at least one embodiment, users have the flexibility to modify detailed design 505 iteratively. For example, a portion of the site can be erased and re-generated by inputting alternative design prompt 501, directing the design generation application 246 to refill the erased portion with a design that includes specific desired features based on alternative design prompt(s) 501.

In various embodiments, when more than one detailed design 505 is to be generated, certain steps of method 900 are repeated. For example, method 900 can return to step 902 to have large language model generate a new set of design tokens 308 representing a new conceptual design layout 507 from design prompt(s) 501. As another example, method 900 can return to step 904 to re-optimize conceptual design layout 507 to generate a new compliant design layout 504, which are processed design generation application 246 following steps 903 to 906.

FIG. 10 sets forth a flow diagram of method steps for optimizing a conceptual design layout 507, according to various embodiments. Although the method steps are described in conjunction with the systems of FIGS. 2, 5, and 6A, persons skilled in the art will understand that any system configured to perform the method steps in any order falls within the scope of the present disclosure. Method 1000 describes the method steps for step 904 of method 900, where design optimizer 506 optimizes a conceptual design layout 507.

The method 1000 begins with step 1001, where constraints compliance module 601 receives conceptual design layout(s) 507. Conceptual design layout(s) 507 are high-level representations that outline the spatial arrangement and elements indicated by the design tokens 308. The received conceptual design layout(s) 507 provide a preliminary structure, including basic spatial configurations and design elements, which will be optimized further to ensure compliance with specified design constraints and requirements.

At step 1002, constraints compliance module 601 sets constraints based on design examples 254 and generate candidate compliant design layout(s) 602. In various embodiments, constraints compliance module 601 uses the WFC algorithm to set constraints based on design examples 254. The WFC algorithm begins by analyzing design examples 254 to identify tile adjacencies, forming a domain of possible constrained states for each tile. Conceptual design layout(s) 602 are initialized with each tile represented as an array of potential states. The conceptual design layout(s) 507 are then converted to WFC pre-constraints, which guide the pre-constraining of tiles to specific states. In some examples, the WFC pre-constraints are used to enforce boundary conditions and controlled generation from the initial pattern. Each of one or more tiles are then selected randomly or deterministically and collapsed or set to a known state from the possible states for that tile to “seed” the design optimization.

At step 1003, design optimizer 506 stores candidate compliant design layout 602 in design layout storage 603. Design layout storage 603 stores candidate compliant design layout 602 for further processing. Design layout storage 603 helps in maintaining and accessing candidate compliant design layout 602 during subsequent steps.

At step 1004, design layout processor 604 processes candidate compliant design layout 602 in design layout storage 603 based on performance metrics 258. Design layout processor 604 evaluates each tile in the candidate compliant design layout(s) 602 using performance metrics 258, such as Shannon entropy, to identify the tile with the lowest performance. The tile with the lowest performance, such as the tile with lowest entropy, is selected for collapse, meaning a single state is chosen for the tile using weighted random selection, while all other potential states are discarded. If multiple tiles have the same lowest performance value, one tile is chosen randomly. In various embodiments, after collapsing a tile, the WFC algorithm updates adjacent tiles and removes all pattern states incompatible with the collapsed tile, continuing until all tiles collapse into a single state. Design layout processor 604 can also add details to the tiles during processing, such as orientations, window placements, and interior walls.

At step 1005, design layout contradiction checker 605 checks for contradictions in the processed candidate compliant design layout(s) 602 included in design layout storage 603. Design layout contradiction checker 605 evaluates whether the current arrangement of tiles satisfies all the given constraints. In some examples, when a contradiction is detected, design layout contradiction checker 605 indicates that the WFC algorithm cannot satisfy all constraints with the current tile configuration. If a contradiction is detected, the method 1000 proceeds to step 1006. If a contradiction is not detected, the method 1000 proceeds to step 1008.

At step 1006, design layout revisor 606 revises candidate compliant design layout 602 with contradictions. In various embodiments, design layout revisor 606 backtracks to a previous state before contradiction, and design layout revisor 606 revises the state choices made for tiles in a candidate compliant design layout 602. The revision includes re-evaluating previous tile collapses and selecting alternative states for the tiles that led to the contradiction. In some embodiments, design layout processor 604 then uses the WFC algorithm to collapse the tiles again using the new states.

At step 1007, design layout contradiction checker 605 checks for contradictions in the revised compliant design layout 602 included in design layout storage 603. Design layout contradiction checker 605 evaluates whether the current arrangement of tiles in candidate compliant design layout 602 satisfies all the given constraints. If a contradiction is detected, the method 1000 proceeds to step 1002, where constraints compliance module 601 generates new candidate compliant design layout 602. If a contradiction is not detected, the method 1000 proceeds to step 1008.

At step 1008, design optimizer 506 checks whether all of the tiles in compliant design layout 602 are processed. If all of the tiles in candidate compliant design layout 602 are processed, the method 1000 terminates. If all of the tiles in candidate compliant design layout 602 are not processed, the method 1000 returns to step 1004 to process the next tile in candidate compliant design layout 602.

In sum, the disclosed techniques generate training data and candidate designs for a design problem specified using one or more design prompts, such as an architectural or engineering designs to be laid out in a multi-dimensional grid. The generation of the training data begins with a design optimizer that generates initial designs that are refined by a design orchestrator to generate a set of design layouts. Each layout is evaluated based on performance metrics, which are used to place the design layouts in a design grid with an axis for each metric. Next, high-performing and diverse parent candidate design layouts are selected from the design grid and the candidate design layout genotypes are mutated to create variations and new design layouts. The new candidate design layouts are generated and evaluated based on the performance metrics. The design grid is then updated with the new candidate design layouts, replacing existing design layouts. The iterative optimization process continues until an optimal set of diverse, high-quality design layouts is achieved. The optimized design layouts are stored as design data, converted into design tokens paired with attributes, and used to train a large language model.

The disclosed techniques also include generating designs using the trained large language model. One or more design prompts are received and provided to the trained large language model. The large language model processes the design prompt and then generates a sequence of design tokens representing a conceptual design layout. A design optimizer refines the conceptual design layout by substituting specific design tiles for each of the tokens in the conceptual design layout. When substituting the specific tiles, the design optimizer applies constraints learned from design examples. When each of the tokens is replaced with a specific design tile without violating the constraints, the resulting layout of design tiles is converted to a complete design. The complete design is then post-processed and converted into a detailed design.

One technical advantage of the disclosed techniques relative to the prior art is the ability to generate diverse and high-performing design outputs that address a broad range of design goals and constraints. By integrating the WFC algorithm and iterative mutation processes, the disclosed techniques overcome the limitations of conventional heuristic-based optimization approaches, which often fail to provide sufficient diversity in design outputs and require extensive manual intervention and fine-tuning. Another advantage of the disclosed techniques is the reduced reliance on large, high-quality design datasets and significant computational resources. By using the WFC algorithm and a genetic algorithm for design selection and mutation, the disclosed techniques reduce the dependency on extensive datasets and allow for the generation of compliant designs that adhere to practical constraints and standards. These technical advantages provide one or more technological improvements over prior art approaches.

1. In some embodiments, a computer-implemented method for generating a design comprises receiving one or more design prompts, generating, based on the one or more design prompts, a plurality of design tokens using a large language model, generating a conceptual design layout from the plurality of design tokens, and optimizing the conceptual design layout to generate a compliant design layout.

2. The computer-implement method of clause 1, further comprising generating one or more randomly selected design prompts for attributes used to train the large language model that are not included in the one or more design prompts.

3. The computer-implemented method of clauses 1 or 2, wherein each of the plurality of design tokens corresponds to a basic design tile type having a plurality of possible specific design tile types.

4. The computer-implemented method of any of clauses 1-3, wherein the conceptual design layout is a two-dimensional or three-dimensional arrangement of tiles corresponding to the design.

5. The computer-implemented method of any of clauses 1-4, wherein optimizing the conceptual design layout comprises identifying for each tile in the conceptual design layout a set of possible states for the tile based on a corresponding design token from the plurality of design tokens and one or more constraints identified from one or more design examples.

6. The computer-implemented method of any of clauses 1-5, wherein optimizing the conceptual design layout further comprises iteratively selecting a tile from the conceptual design layout, choosing a single state for the selected tile from the set of possible states, and updating the set of possible states for other tiles in the conceptual design layout based on the single state.

7. The computer-implemented method of any of clauses 1-7, wherein optimizing the conceptual design layout further comprises, in response to one of the other tiles having no possible states, choosing a different state for the selected tile.

8. The computer-implemented method of any of clauses 1-7, wherein selecting the tile comprises determining that the selected tile has a lowest entropy among each of the tiles in the conceptual design layout for which a respective single state has not been chosen.

9. The computer-implemented method of any of clauses 1-8, wherein the iterating continues until each tile in the conceptual design layout has a chosen state.

10. The computer-implemented method of any of clauses 1-9, wherein optimizing the conceptual design layout comprises setting one or more tiles in the conceptual design layout to an initial state from the set of possible states before iterating.

11. The computer-implemented method of any of clauses 1-10, further comprising generating, based on the one or more design prompts, a second plurality of design tokens using the large language model, generating a second conceptual design layout from the second plurality of design tokens, and optimizing the second conceptual design layout to generate a second compliant design layout.

12. The computer-implemented method of any of clauses 1-11, further comprising reoptimizing the conceptual design layout to generate a second compliant design layout.

13. The computer-implemented method of any of clauses 1-12, further comprising processing the compliant design layout to generate a detailed design suitable for processing by building information modeling (BIM) software.

14. In some embodiments, one or more non-transitory computer readable media store instructions that, when executed by one or more processors, cause the one or more processors to perform the steps of receiving one or more design prompts, generating, based on the one or more design prompts, a plurality of design tokens using a large language model, generating a conceptual design layout from the plurality of design tokens, and optimizing the conceptual design layout to generate a compliant design layout.

15. The one or more non-transitory computer-readable media of clause 14, wherein the steps further comprise generating one or more randomly selected design prompts for attributes used to train the large language model that are not included in the one or more design prompts.

16. The one or more non-transitory computer-readable media of clauses 14 or 15, wherein each of the plurality of design tokens corresponds to a basic design tile type having a plurality of possible specific design tile types.

17. The one or more non-transitory computer-readable media of any of clauses 14-16, wherein optimizing the conceptual design layout comprises identifying for each tile in the conceptual design layout a set of possible states for the tile based on a corresponding design token from the plurality of design tokens and one or more constraints identified from one or more design examples, and iteratively selecting a tile from the conceptual design layout, choosing a single state for the selected tile from the set of possible states, and updating the set of possible states for other tiles in the conceptual design layout based on the single state.

18. The one or more non-transitory computer-readable media of any of clauses 14-17, wherein the steps further comprise generating, based on the one or more design prompts, a second plurality of design tokens using the large language model, generating a second conceptual design layout from the second plurality of design tokens, and optimizing the second conceptual design layout to generate a second compliant design layout.

19. The one or more non-transitory computer-readable media of any of clauses 14-18, wherein the steps further comprise reoptimizing the conceptual design layout to generate a second compliant design layout.

20. In some embodiments, a system comprises one or more memories storing instructions, and one or more processors that are coupled to the one or more memories and, when executing the instructions, are configured to receive one or more design prompts, generate, based on the one or more design prompts, a plurality of design tokens using a large language model, generate a conceptual design layout from the plurality of design tokens, and optimize the conceptual design layout to generate a compliant design layout.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a design, the method comprising:
receiving one or more design prompts;
generating, based on the one or more design prompts, a plurality of design tokens using a large language model;
generating a conceptual design layout from the plurality of design tokens; and
optimizing the conceptual design layout to generate a compliant design layout.

2. The computer-implement method of claim 1, further comprising generating one or more randomly selected design prompts for attributes used to train the large language model that are not included in the one or more design prompts.

3. The computer-implemented method of claim 1, wherein each of the plurality of design tokens corresponds to a basic design tile type having a plurality of possible specific design tile types.

4. The computer-implemented method of claim 1, wherein the conceptual design layout is a two-dimensional or three-dimensional arrangement of tiles corresponding to the design.

5. The computer-implemented method of claim 1, wherein optimizing the conceptual design layout comprises identifying for each tile in the conceptual design layout a set of possible states for the tile based on a corresponding design token from the plurality of design tokens and one or more constraints identified from one or more design examples.

6. The computer-implemented method of claim 5, wherein optimizing the conceptual design layout further comprises iteratively:
selecting a tile from the conceptual design layout;
choosing a single state for the selected tile from the set of possible states; and
updating the set of possible states for other tiles in the conceptual design layout based on the single state.

7. The computer-implemented method of claim 6, wherein optimizing the conceptual design layout further comprises, in response to one of the other tiles having no possible states, choosing a different state for the selected tile.

8. The computer-implemented method of claim 6, wherein selecting the tile comprises determining that the selected tile has a lowest entropy among each of the tiles in the conceptual design layout for which a respective single state has not been chosen.

9. The computer-implemented method of claim 6, wherein the iterating continues until each tile in the conceptual design layout has a chosen state.

10. The computer-implemented method of claim 6, wherein optimizing the conceptual design layout comprises setting one or more tiles in the conceptual design layout to an initial state from the set of possible states before iterating.

11. The computer-implemented method of claim 1, further comprising:
generating, based on the one or more design prompts, a second plurality of design tokens using the large language model;
generating a second conceptual design layout from the second plurality of design tokens; and
optimizing the second conceptual design layout to generate a second compliant design layout.

12. The computer-implemented method of claim 1, further comprising reoptimizing the conceptual design layout to generate a second compliant design layout.

13. The computer-implemented method of claim 1, further comprising processing the compliant design layout to generate a detailed design suitable for processing by building information modeling (BIM) software.

14. One or more non-transitory computer readable media storing instructions that, when executed by one or more processors, cause the one or more processors to perform the steps of:
receiving one or more design prompts;
generating, based on the one or more design prompts, a plurality of design tokens using a large language model;
generating a conceptual design layout from the plurality of design tokens; and
optimizing the conceptual design layout to generate a compliant design layout.

15. The one or more non-transitory computer-readable media of claim 14, wherein the steps further comprise generating one or more randomly selected design prompts for attributes used to train the large language model that are not included in the one or more design prompts.

16. The one or more non-transitory computer-readable media of claim 14, wherein each of the plurality of design tokens corresponds to a basic design tile type having a plurality of possible specific design tile types.

17. The one or more non-transitory computer-readable media of claim 14, wherein optimizing the conceptual design layout comprises:
identifying for each tile in the conceptual design layout a set of possible states for the tile based on a corresponding design token from the plurality of design tokens and one or more constraints identified from one or more design examples; and
iteratively:
selecting a tile from the conceptual design layout;
choosing a single state for the selected tile from the set of possible states; and
updating the set of possible states for other tiles in the conceptual design layout based on the single state.

18. The one or more non-transitory computer-readable media of claim 14, wherein the steps further comprise:
generating, based on the one or more design prompts, a second plurality of design tokens using the large language model;
generating a second conceptual design layout from the second plurality of design tokens; and
optimizing the second conceptual design layout to generate a second compliant design layout.

19. The one or more non-transitory computer-readable media of claim 14, wherein the steps further comprise reoptimizing the conceptual design layout to generate a second compliant design layout.

20. A system comprising:
one or more memories storing instructions, and
one or more processors that are coupled to the one or more memories and, when executing the instructions, are configured to:
receive one or more design prompts;
generate, based on the one or more design prompts, a plurality of design tokens using a large language model;
generate a conceptual design layout from the plurality of design tokens; and
optimize the conceptual design layout to generate a compliant design layout.
